(19) United States
(12) Patent Application Publication
(10) Pub. No.: US 2023/0338931 A1
(43) Pub. Date: Oct. 26, 2023

(54) METHOD FOR MANUFACTURING TITANIUM DIOXIDE NANOFIBERS DOPED WITH NOBLE METALS

(71) Applicant: INDUSTRY-ACADEMIC COOPERATION FOUNDATION, YONSEI UNIVERSITY, Seoul (KR)

(72) Inventors: Jung Ho HWANG, Seoul (KR); Sang Mo KANG, Gyeonggi-do (KR); Gi Hyeon YU, Seoul (KR); Do Heon KIM, Seoul (KR)

(21) Appl. No.: 18/082,298

(22) Filed: Dec. 15, 2022

(30) Foreign Application Priority Data
Apr. 22, 2022 (KR) 1020220050147

(51) Int. Cl. B01J 23/50; B01J 21/06; B01J 35/00; B01J 35/06; B01J 37/34; B01J 37/08; B01J 37/12; B01J 37/00

(52) U.S. Cl. CPC B01J 23/50; B01J 21/063; B01J 35/0013; B01J 35/06; B01J 35/004; B01J 37/347; B01J 37/088; B01J 37/12; B01J 37/0018

(57) ABSTRACT

The present invention relates to a method for preparing titanium dioxide nanofibers surface-doped with noble metal ions through electrohydrodynamic transport. Titanium dioxide nanofibers according to the present invention can be used for reducing viruses, bacteria, and volatile organic compounds in the air.

### TECHNICAL FIELD

The present invention relates to a method for preparing titanium dioxide nanofibers surface-doped with noble metal ions through electrohydrodynamic transport.

Titanium dioxide nanofibers according to the present invention can be used for reducing viruses, bacteria, and volatile organic compounds in the air.

### BACKGROUND ART

Various types of microorganisms such as bacteria, fungi, and viruses as well as fine dust, nitrogen oxides, and volatile organic compounds float in the air indoors. These microorganisms are known to adversely affect health by causing diseases such as atopic dermatitis, allergic rhinitis, bronchial asthma, skin mycosis, and building syndrome.

In order to solve this problem, a technique for reducing airborne microorganisms through an ion generating device using a low-temperature plasma called SPi (super plasma ion) or NPi (nano plasma ionizer) has been proposed. In addition, as a technology related to an air purifier, a pre-class antibacterial filter using various types of antibacterial substances (pine needle extract, chitosan, kimchi extract) and the like have been proposed. However, these techniques also fail to demonstrate a satisfactory antibacterial effect.

In addition, a technology applied to air purifiers has been proposed as a method of generating cluster ions of H+ and O²⁻ ions using AC voltage to remove internal hydrogen necessary for survival of viruses by being attached to viruses by electrical force, but the core of such technology, which is the ion generating device, is not significantly different from existing plasma, and the generation of ozone remains an unresolved problem.

Moreover, some automobile manufacturers are conducting research on interior air purification of vehicles using low-concentration ozone and selling products that can be attached within vehicles, but it has not been proven that low-concentration ozone has an antibacterial function.

Furthermore, from a medical point of view such as allergies, there has been interest in airborne microbial research, and research has been conducted since the early 1990s. In relation to airborne microbial control technology, electric ions are artificially released to conduct experiments related to affecting vitality, and control technology using ultraviolet rays has been presented, but there has also been a failure to show satisfactory effects.

In particular, as infection by airborne microorganisms such as novel swine-origin influenza A (H1N1) has recently become an issue, the interest of consumers in indoor air quality is increasing day by day, and in order to meet consumer demand, various studies related to the reduction of airborne microorganisms are also in progress within the filter manufacturing industry.

In addition, the use of a deodorant that is readily used to reduce odor in everyday life is not a reduction method in a strict sense as it uses a different scent to cover up an odor. An adsorption method using a porous material is used for multiple purposes because of its low installation cost and easy management, and recently domestic and foreign researchers are introducing methods, such as a low-temperature condensation method that condenses and recovers exhaust gas containing odorous substances and a plasma method that decomposes odorous substances using electrons and radicals generated from corona discharge.

Moreover, respiratory masks are classified and managed by the Ministry of Food and Drug Safety as quasi-drugs, and health masks to protect against respiratory diseases, odors, fumes, etc. are becoming popular, but these masks are not comfortable to wear because the internal temperature rises due to breathing, and a heat exchange method that does not cause discomfort to the wearer while performing high-efficiency particle reduction and development of adhesion materials and the like are in progress.

As described above, there is a demand for antibacterial action capability in various fields, and research related to materials applicable to filter mediums, antibacterial masks and the like while performing antibacterial action is in demand.

Meanwhile, various manufacturing methods for noble metal/titanium dioxide nanocomposites including sol-gel, hydrothermal, solvothermal, photoreduction and photodeposition processes have been developed.

Among them, electrohydrodynamic spraying (electrospray) and spinning (electrospinning) technologies are easy, low-cost, and efficient processes for generating solid nanoparticles and fibers from Ag and Ti precursor solutions using electric charges. Nanoparticles formed by electrospraying can produce a highly functional structure with photocatalytic activity and have the advantage of exhibiting high component uniformity. Despite these advantages, in order to use electrostatically sprayed nanoparticles for air purification, an additional process of supporting nanoparticles on a basic filter or support must be conducted in advance, which causes a large variation related to the coating density of nanoparticles. In addition, rescattering of nanoparticles due to poor adhesion stability between nanoparticles and the support can degrade the quality of ambient air and air filter composites.

On the other hand, the advantage of electrospun nanofibers (NF) is that various functional nanocomposites can be directly used as air filters without a support. However, when electrospinning a solution of a noble metal precursor and a polymer composite to produce a photocatalyst activated under visible light, most of the metal components are embedded inside the fibers, so the area exposed to light is reduced. This limits the occurrence of a local surface plasmon resonance phenomenon, which causes photocatalytic reactions under visible light, and the performance of noble metals having antibacterial ability.

### PRIOR ART LITERATURE

### Patent Literature

1. Republic of Korea Patent No. 10-1777975

### DISCLOSURE

### Technical Problem

An object of the present invention is to provide a new technology capable of intensively positioning noble metal components only on the surfaces of nanofibers in order to compensate for disadvantages related to electrospinning technology.

The present invention can efficiently expose even a small amount of the noble metal component on the surface and can manufacture a photocatalyst fiber doped with a noble metal at one instance without an additional process in which the noble metal particles are directly supported on the photocatalyst. The present invention compensates for the disadvantages related to a general electrospinning process and is different from the prior art in that it can manufacture titanium dioxide nanofibers doped with noble metals in a large amount, which are applicable on an industrial scale.

### Technical Solution

In order to achieve the above object, the present invention comprises a method for producing titanium dioxide nanofibers doped with a noble metal on the surfaces providing the steps of electrospinning an electrospinning solution containing a noble metal inorganic salt, a titanium precursor, and a polymer while applying a negative voltage to prepare nanofibers; and heat-treating the electrospun nanofibers to expose noble metals on the surface of the nanofibers and oxidizing the titanium precursor to titanium dioxide.

In addition, the present invention comprises a titanium dioxide nanofiber whose surface is doped with a noble metal manufactured by the above-described manufacturing method.

### Advantageous Effects

Titanium dioxide nanofibers according to the present invention can greatly increase the performance of existing antibacterial/antiviral/deodorizing filters and can greatly increase the performance of filters utilizing low-cost power via visible light. In addition, even in the absence of light, antibacterial/antiviral performance can be maintained due to presence of the doped silver nanoparticles.

Therefore, the titanium dioxide nanofibers according to the present invention can be applied to various applications and industries, and it is judged that they will dominate the eco-friendly industrial market based on offering low price, low energy, and high efficiency and occupy an advantageous position with respect to entering the global market.

### DESCRIPTION OF DRAWINGS

FIG. 1 is a schematic diagram showing a method of manufacturing metal/polymer mixed nanofibers using a general electrospinning technique.

FIG. 2 is a schematic diagram showing a method of producing titanium dioxide nanofibers having silver particles located therein by heat-treating the nanofibers prepared by the method of FIG. 1.

FIGS. 3A and 3B, together, form a schematic diagram showing a general electrospinning device and method. Reference number 1 of FIG. 3A joins to link to reference number 1′ of FIG. 3B. Reference number 2 of FIG. joins to reference number 2′ of FIG. 3B. In FIG. 3A, the power supply is a high voltage power supply.

FIGS. 4A and 4B, together, form a schematic diagram showing a method of manufacturing titanium dioxide nanofibers doped with noble metals on the surface through electrospinning and heat treatment processes using negative voltage and noble metal inorganic salts according to the present invention. Reference number 6 of FIG. 4A joins with reference number 6′ of FIG. 4B to shown continuation of the method. In FIG. 4A, reference number 4 is an AgNo3/TTIP/PVP/Ethanol solution and reference number 5 is a rotating drum collector. In FIG. 4B, reference number 7 is an insulator, reference number 8 is a siliconit heater, and reference number 9 is an alumina tube. In FIG. 4A, reference number 10 refers to a high voltage supply.

FIG. 5 is a mapping image of AgNO₃/TTIP/PVP nanofibers electrospun with a negative voltage utilizing energy dispersive spectroscopy of a scanning electron microscope (SEM-EDS).

FIG. 6A is an IR spectrum of TTIP/PVP nanofibers electrospun with a positive voltage, AgNO₃/TTIP/PVP nanofibers electrospun with a positive voltage, and AgNO₃/TTIP/PVP nanofibers electrospun with a negative voltage.

FIG. 6B shows the atomic content of AgNO₃/TTIP/PVP nanofibers (before pyrolysis) and Ag/TiO₂ nanofibers (after pyrolysis) that were electrospun with positive or negative voltage with respect to etching depth.

FIG. 6C shows the XRD pattern results of Ag/TiO₂ nanofibers.

FIG. 6D shows a TEM-EDS mapping image of Ag/TiO₂ nanofibers (1.0 mol %).

FIG. 6E shows the UV-vis absorption spectra of Ag/TiO₂ nanofibers (0, 0.25, 0.5, 0.75, 1%) and a plot (inset) of (ah) % versus energy (hu).

FIG. 6F shows the PL spectrum of Ag/TiO₂ nanofibers in the range of 350 to 800 nm.

FIGS. 7A and 7B show the photocatalytic decomposition of MB based on the Ag/TiO₂ photocatalyst under UV irradiation (FIG. 7A) and visible light irradiation (FIG. 7B).

FIG. 8 shows the results of antibacterial analysis of Ag/TiO₂ nanoparticles with respect to E. coli and S. epidermidis.

FIG. 9 shows the results of antibacterial analysis of TiO₂ nanofibers with respect o E. coli and S. epidermidis.

FIG. 10A to 10D show air medium test results for evaluating the antibacterial activity of Ag/TiO₂ when using gram-negative bacteria (E. coli) and gram-positive bacteria (S. epidermidis).

FIG. 10E is a schematic diagram showing the synthesis of Ag/TiO₂ nanofibers and nanoparticles.

FIG. 10F shows the antibacterial efficiency of Ag/TiO₂ towards E. coli and S. epidermidis in the air.

FIGS. 10G and 10H show images and diameters of inhibition zones for ESBL-produced E. coli and MRSA.

FIGS. 11A-11H show the results of antiviral analysis related to H1N1 and H3N2 using Ag/TiO₂.

FIGS. 12A-12D shows the photocatalytic acetaldehyde decomposition efficiency of Ag/TiO₂ under irradiation of (FIG. 12A) UV light and (FIG. 12B) visible light, and also shows Ag/TiO₂ photocatalytic acetaldehyde decomposition efficiency under irradiation of (FIG. 12C) UV light and (FIG. 12D) visible light based on a continuous flow reaction. It represents the amount of CO₂ released during the photocatalytic batch reaction of acetaldehyde in the presence of TiO₂.

### MODES OF THE INVENTION

Since the present invention can make various changes and have various embodiments, specific embodiments will be illustrated in the drawings and described in detail in the detailed description.

However, this is not intended to limit the present invention to specific embodiments and should be understood to include all modifications, equivalents, and substitutes included in the spirit and scope of the present invention.

In the present invention, the term “nano” may mean a size in nanometer (nm) units, for example, 1 to 1,000 nm, but is not limited thereto. In addition, the term “nanoparticle” in this specification may refer to particles having an average particle diameter in the nanometer (nm) scale, for example, to mean particles having an average particle diameter of 1 to 1,000 nm, but is not limited thereto.

The present invention relates to a method for producing titanium dioxide nanofibers doped with noble metals on the surfaces.

The manufacturing method according to the present invention comprises the steps of preparing nanofibers by electrospinning an electrospinning solution containing a noble metal inorganic salt, a titanium precursor, and a polymer while applying a negative voltage (hereinafter, an electrospinning step); and
heat-treating the electrospun nanofibers to expose noble metals on the surface of the nanofibers and oxidizing the titanium precursor to titanium dioxide (hereinafter, a heat treatment step).

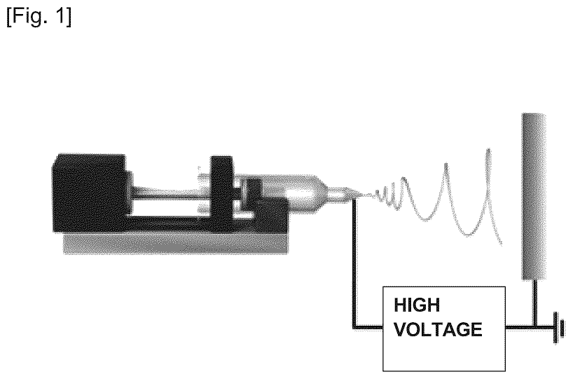

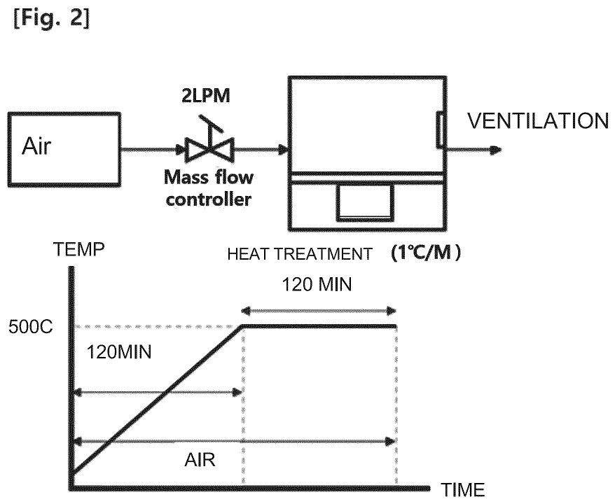

In the present invention, FIG. 1 is a schematic diagram showing a method of manufacturing metal/polymer mixed nanofibers using a general electrospinning technique, and FIG. 2 is a schematic design showing a method of manufacturing nanofibers with silver particles located inside utilizing heat treatment of the titanium dioxide nanofibers prepared by the method according to FIG. 1.

A general method for producing titanium dioxide nanofibers having silver (Ag) particles therein uses a method of electrospinning an electrospinning solution containing a silver precursor, a titanium precursor, and a polymer with a high voltage, followed by heat treatment. However, in this case, the silver particles capable of causing a photocatalytic reaction and an antibacterial/antiviral reaction based on effects of LSPR under visible light are located inside the nanofibers, thereby reducing the efficiency of the photocatalytic reaction as well as antibacterial/antiviral efficiency.

The present invention compensates for the disadvantages related to electrospinning technology and provides a new manufacturing method capable of intensively positioning noble metal particles only on the surface of nanofibers.

In the present invention, the electrospinning step is a step of preparing nanofibers by electrospinning an electrospinning solution containing a noble metal inorganic salt, a titanium precursor, and a polymer while applying a negative voltage.

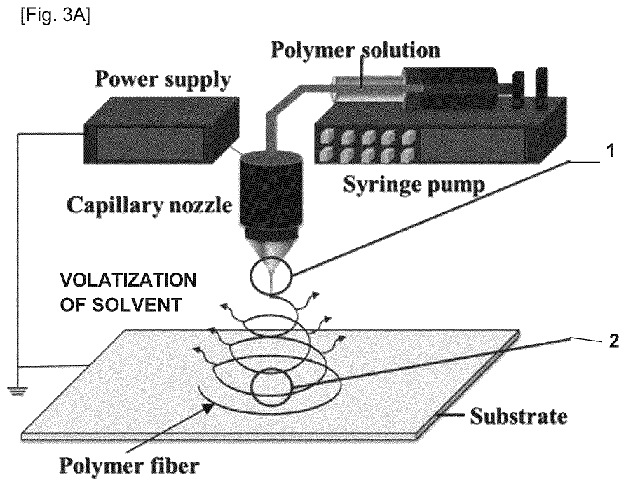

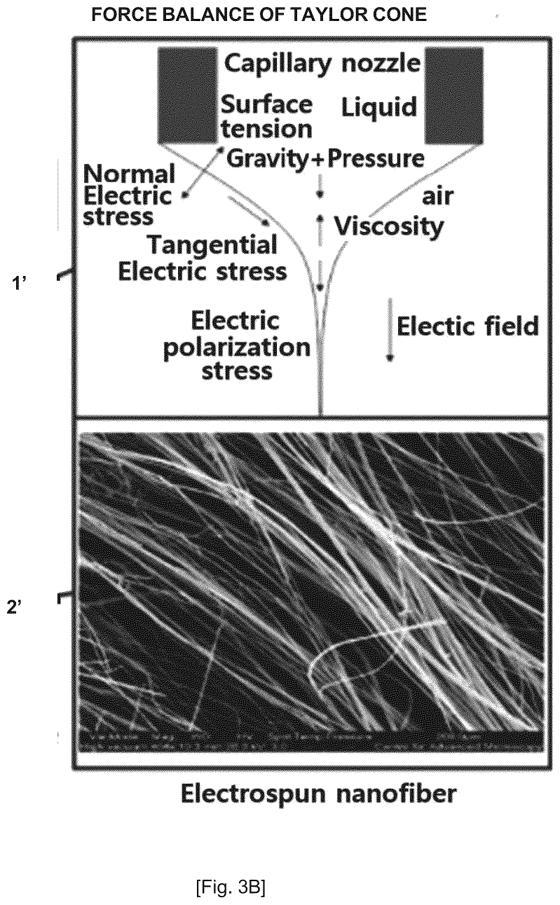

In the present invention, “electrospinning” is a method of implementing fibers having diameters ranging from micrometers to nanometers by using an electric field. The electrospinning process is simple, there is no restriction on the selection of materials, and it is easy to control specific surface areas, porosity, structure and size to a high degree based on the shape. The scope of application is broad, ranging from the biomedical engineering to high-tech industries. FIG. 3 is a schematic diagram showing a general electrospinning device and method, and the electrospinning device, as shown in FIG. 3, comprises the three components of a high voltage power supply, a nozzle, and a substrate for collecting fibers.

As shown in FIG. 3, the electrospinning solution is injected through a nozzle at a constant speed through a syringe pump. At this time, one electrode is charged by injecting electric charges into the electrospinning solution discharged by connecting the high voltage applicator and the nozzle tip, and the opposite electrode is connected to the substrate. The polymer liquid sprayed from the tip of the nozzle forms a hemispherical shape due to surface tension. At this time, when high voltage is applied to the nozzle tip, the liquid polymer droplets change to a form of cones of a funnel shape (Taylor cone shapes) due to the mutual electrostatic repulsive force between surface charges and the Coulomb force applied to the external electric field. That is, when an electric field of a certain intensity is applied to the nozzle tip in contact with the electrospinning solution, unipolar charges continue to accumulate in the electrospinning solution, and the mutual repulsive force of the same charges overcomes the surface tension of the electrospinning solution, forming a hemispherical shape at the tip of the nozzle. The phase is emitted as a Taylor cone-shaped jet, which collects the fibers in the direction of the oppositely charged or grounded substrate. During the electrospinning process, volatilization of the solvent is accompanied before the liquid jet reaches the substrate, and fine fibers randomly arranged on the top of the dust collector can be obtained. The parameters of the electrospinning process include solution viscosity, surface tension, conductivity, capillary tube properties (distance from needle tip to substrate and electric field size), solution temperature, humidity, and flow rate within an electric field. At this time, the motion of the fluid can be expressed by equations for convection, diffusion, differential pressure, surface tension, gravity, and electric force of the fluid as shown in Equation 1 below.

$$\begin{matrix}∇ \cdot \vec{u} = 0 \\ ρ [ \frac{d \vec{u}}{dt} + ( \vec{u} \cdot {{∇}^{↙}}^{convection} ) \vec{u} ] = μ {{{∇}^{2}}^{↙}}^{diffussion} \vec{u} - {{∇}^{↙}}^{\begin{matrix}differential \\ pressure\end{matrix}} p + σ {{κ}^{↙}}^{\begin{matrix}surface \\ tension\end{matrix}} δ \vec{n} + {{ρ}^{↙}}^{gravity} \overline{g} + {{\overline{{F}_{e}}}^{↙}}^{\begin{matrix}electrical \\ body force\end{matrix}}\end{matrix} \qquad [ Equation 1 ]$$

However, electrospinning possesses disadvantages in that it is difficult to manufacture uniform nanofibers because the behavior based on utilizing variable control has not been fully identified, it is difficult to handle the manufactured nanofibers, and production volume is very low. Because of the advantages of being able to easily manufacture nanofibers, being able to manufacture not only polymers but also various other materials such as metals and carbons in the form of nanofiber webs, and being very economical, many studies are being conducted all over the world.

Nanofibers produced through such electrospinning are applied in various fields, such as energy, electronics, biological, medical, and textile fields. Recently, one of the most exciting research topics in the field of electrospinning is the incorporation of functional nanoparticles (NPs) into electrospun fibers. When NPs are included in fibers, better performance can be imparted to the fibers themselves, and NPs can be preserved from undergoing corrosion or oxidation. Electrospun NP-containing composite fibers are flexible and can be used for various purposes depending on the type of NP, so there is great potential related to their application. When electrospinning NPs with anisotropic structures such as nanorods (NRs) and nanowires (NWs), the NPs will be aligned within fibers to a certain extent to reduce Gibbs free energy, so the electrospinning technique is simple and can be used as an effective self-assembly method. Self-assembly methods are prone to environmental changes, and the assembled structures are usually solution or template-based. When using electrospinning, if the NPs are stabilized within the electrospun fiber, the disadvantages related to conventional self-assembly methods can be overcome. In addition, electrospinning generally does not require a high-power surface functionalization process. It simply requires the use of a suitable solvent in which the NPs can be uniformly dispersed as well as a polymer that is soluble within the solvent.

The present invention provides an electrospinning solution containing a noble metal inorganic salt, a titanium precursor, and a polymer. According to the present invention, noble metal inorganic salts can be uniformly dispersed in the electrospinning solution, and noble metal particles can be stabilized in nanofibers after performing electrospinning.

In one embodiment, noble metals may be used to impart photocatalytic effects and antibacterial/antiviral effects to nanofibers. In the present invention, the noble metal may be silver, and the silver may cause a photocatalytic reaction and an antibacterial/antiviral reaction under visible light based on the LSPR effect.

The noble metal inorganic salt may be formed into noble metal particles through heat treatment after performing electrospinning. These noble metal inorganic salts may include and use at least one selected from the group consisting of silver nitrate (AgNO₃), chloroplatinic acid (H2PtCl₆), palladium chloride (PdCl₂), ruthenium chloride (RuCl₃), chloroauric acid (HAuCl₄), Nickel chloride (NiCl₂), copper chloride (CuCl₂), gold chloride (AuCl, AuCl₃), palladium nitrate (Pd(NO₃)₂·2H₂O), silver chloride (AgCl), chloroauric acid (HAuCl₄), palladium chloride acid sodium (Na₂PdCl₄), platinum chloride (PtCl₄), tetraaminepalladium dinitrate (Pd(NH₃)₄(NO₃)₂), and palladium chloride (Cl₂Pd).

Noble metal inorganic salts have a higher degree of ionization than organic salts and can be easily separated into cations and anions. It is difficult to dissolve organic salts, especially since a non-polar part such as a methyl group interacts with the polymer. On the other hand, inorganic salts are negatively charged, but ions are easily moved even within polymers due to the presence of positive charges.

The content of the noble metal inorganic salt is not particularly limited, and may be 0.1 to 5% by weight based on the total weight of the electrospinning solution.

In one embodiment, the titanium precursor may form TiO₂ through heat treatment after performing electrospinning.

The type of the titanium precursor is not particularly limited and may be one or more selected from the group consisting of titanium isopropoxide (TTIP), titanium butoxide (C₁₆H₃₆O₄Ti), and titanium (IV), acetylacetonate (Ti(C₅H₇O₂)₄).

The content of the titanium precursor is not particularly limited, and may be 1 to 10% by weight based on the total weight of the electrospinning solution.

In one embodiment, the molar ratio of the noble metal inorganic salt to titanium (Ti) in the titanium precursor may be 0.1 to 2%, or 0.1 to 1.0%, or 0.3 to 0.5%.

In one embodiment, the polymer comprises the nanofibers generated during electrospinning and at the same time serves to embed metal components (Ti and noble metals). The polymer is decomposed upon performing heat treatment.

The polymer is not particularly limited as long as it is used for electrospinning, and may be at least one selected from the group consisting of, for example, polyvinyl pyrrolidone (PVP), polyacrylonitrile (PAN), polyurethanes (PU), polybenzene midazole (Polybenzimidazole, PBI), polycarbonate (PC), polyvinyl alcohol (PVA), polylactic acid (PLA), polyethylene-co-vinyl acetate (PEVA), polymethacrylate (PMMA), polyethylene oxide (PEO), polyaniline (PANI), polyvinylchloride (PVC), polycaprolactone (PCL), polyether imide (PEI), poly(vinylidene fluoride) (PVDF), polyethylene glycol (PEG), poly(2-hydroxyethyl methacrylate) (HEMA), collagen, poly(ferrocenyldimethylsilane) (PFDMS), and polystyrene (PS).

The content of the polymer is not particularly limited, and may be 5 to 20% by weight based on the total weight of the electrospinning solution.

In one embodiment, the solvent of the electrospinning solution is not particularly limited as long as it can be applied to electrospinning, and may be at least one selected from the group consisting of dimethylformamide (DMF), dichloromethane, distilled water, chloroform, acetone, ethanol, hydrochloric acid, formic acid, tetrahydrofuran, and isopropanol.

In one embodiment, the concentration, viscosity, molecular weight, etc. of the polymer of the electrospinning solution are not particularly limited.

In the present invention, nanofibers may be prepared by performing electrospinning while applying a negative voltage to the electrospinning solution.

In one embodiment, the electrospinning device may install an electrospinning solution on a syringe equipped with a metal nozzle, apply a negative voltage from the voltage unit to the metal nozzle, pressurize the syringe pump, and spray fibers toward the collector.

During the electrospinning process, when a negative voltage is applied to the nozzle tip, in the case of inorganic salts, anions and cations are separated, and positive ions move toward the tip of the nozzle due to the negative charge formed at the nozzle tip, and they can be intensively formed on the surface layer of nanofibers.

In one embodiment, the surface layer portion can have a thickness within 20%, within 18%, within 16%, within 14%, within 12%, within 10%, within 8%, within 6%, within 4% or within 2% (excluding 0) of the average diameter from the surface of the nanofiber toward the inside of the surface layer.

In one embodiment, the flow rate of the electrospinning solution may be 1 to 15 μL/min, the inner diameter of the nozzle may be 0.4 to 2 mm, and the distance between the nozzle and the collector may be 10 to 50 cm. Based on these conditions, the desired nanofibers of the present invention can be easily obtained.

In one embodiment, the negative voltage may be −5000 V to −20000 V. If excluded from the above range, there may be a problem in that it will be difficult to form a Taylor cone while conducting electrospinning.

In one embodiment, when electrospinning is performed while a negative voltage is applied to an electrospinning solution containing silver nitrate as a noble metal inorganic salt, silver ions having a positive polarity may form a negatively charged metal due to the negative electric potential of the metal nozzle tip. Silver ions can move toward the nozzle, and thus form nanofibers in which silver is concentrated in the surface layer after the solvent is evaporated.

In the present invention, the heat treatment step is a step of heat-treating the nanofibers prepared during the electrospinning step to expose noble metals on the surface of the nanofibers and oxidizing the titanium precursor to titanium dioxide.

Through the heat treatment process, components other than noble metal components and titanium may be thermally decomposed. By conducting heat treatment, a part of the nanofibers may be exposed on the outer surface of the noble metal particles, and the titanium precursor may be oxidized to titanium dioxide.

In one embodiment, the heat treatment may be performed at 300 to 600° C., 400 to 600° C., or 450 to 550° C. In addition, heat treatment may be performed for 30 to 180 minutes or 60 to 150 minutes. If the temperature and time are outside the aforementioned range, there is a concern that the noble metal particles will not protrude or the noble metal nanoparticles will be separated. That is, when utilizing the above temperature and time ranges, nanofibers firmly doped with noble metal particles can be manufactured.

In particular, the present invention can manufacture titanium dioxide nanofibers through a roll-to-roll continuous process.

In the present invention, the term “roll-to-roll” refers to a system that continuously performs several processes by transferring a web (a material that is thin and long compared to its width, such as a web, film, paper, etc.) using several driving units and rolls.

In addition, in the present invention, the term “continuous process” means that the electrospinning step and the heat treatment step are performed as one continuous process (one-step).

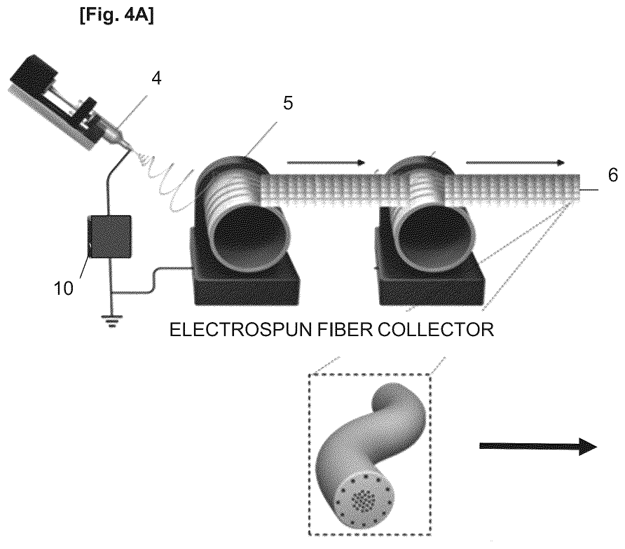

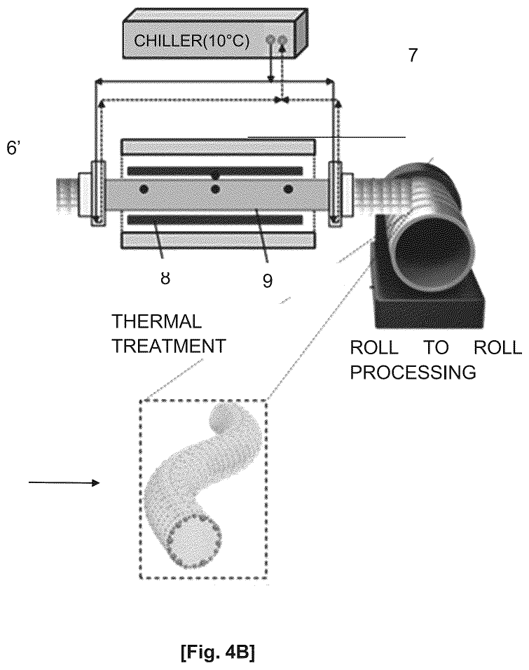

In the present invention, FIG. 4 is a schematic diagram showing a method of manufacturing titanium dioxide nanofibers doped with noble metal on the surface by performing electrospinning and heat treatment using a negative voltage and an inorganic salt according to the present invention.

In the present invention, titanium dioxide nanofibers can be manufactured by a roll-to-roll nanofiber manufacturing device (hereinafter referred to as a roll-to-roll device). Such a roll-to-roll device may include a heat treatment device and a first roller and a second roller disposed to be spaced apart from each other.

In one embodiment, the first roller may serve as a substrate on which nanofibers are produced by electrospinning the pre-spinning solution. The first roller may be a rotating drum, and the electrospinning solution may be electrospun on the rotating drum.

The nanofibers produced by performing electrospinning on the first roller may be transferred to a second roller and wound around the second roller.

In one embodiment, the heat treatment may be performed while the nanofibers are transferred from the first roller to the second roller, and the roll-to-roll device is positioned between the first roller and the second roller and may include a heat treatment device that heat-treats the nanofibers. The aforementioned heat treatment may utilize a general heat treatment method in the art.

Moreover, the present invention relates to titanium dioxide nanofiber whose surface is doped with a noble metals manufactured by the above-described manufacturing method.

The titanium dioxide nanofibers can include titanium dioxide nanofibers and noble metal particles protruding from the surface of the titanium dioxide nanofibers.

In one embodiment, the noble metal may be one or more selected from the group consisting of silver, gold, platinum, palladium, ruthenium, nickel, and copper.

In one embodiment, the noble metal particles may be spherical.

In one embodiment, the average particle diameter of the noble metal particles may be 1 to 20 nm.

In one embodiment, the amount of noble metal particles protruding on the surface of the nanofibers may be 0.1 to 5% by volume based on the total volume of the particles.

In the present invention, titanium dioxide nanofibers can provide a composite capable of providing certain properties through the doped noble metal particles, for example, photocatalytic properties. In addition, due to the silver particles that can serve as a photocatalyst, an improved antibacterial effect can be exhibited when visible light is received.

Since the titanium dioxide nanofibers according to the present invention are harmless to the human body, they can have various uses.

In one embodiment, titanium dioxide nanofibers doped with silver particles have visible light-based antibacterial activity and VOC oxidizing ability, so they can be used in integrated air filter applications such as masks, air purifiers, clothing and respirators.

In the present invention, depending on the type of noble metal used, for example, when silver is used as a noble metal, the nanofibers that are produced can be expressed as Ag/TiO₂ nanofibers.

In an embodiment of the present invention, Ag/TiO₂ nanofibers (NF) doped with silver (Ag) were synthesized, and the multifunctionality of airborne virus and bacteria inactivation and acetaldehyde oxidation was evaluated under visible light conditions.

The following characteristics can be confirmed through the examples of the present invention.

First, electrospinning of an electrospinning solution containing a noble metal inorganic salt and a polymer at a negative electric potential results in electrohydrodynamic transport of silver ions towards the surface of the fiber. As a result, silver is concentrated on the surface of the TiO₂ nanofibers, and a uniformly distributed silver layer can be synthesized after conducting pyrolysis.

Second, 0.5% Ag/TiO₂ nanofibers exhibit the smallest crystallite size, highest MB decomposition efficiency, lowest bandgap energy, smallest silver size and lowest recombination rate of photoelectron carriers, allowing it to serve as a photocatalyst for visible light.

Third, Ag/TiO₂ nanofibers in liquid and air mediums can show excellent antibacterial and antiviral performance under UV or visible light conditions.

Fourth, based on the LSPR effect of Ag/TiO₂ nanofibers, it is possible to have complete and sustainable photo-oxidation of acetaldehyde under visible light.

Finally, the electrospun Ag/TiO₂ nanofibers exhibit superior antibacterial and photooxidation performance compared to that of the electrospray-fabricated Ag/TiO₂ nanoparticles.

The present invention demonstrates the potential of Ag/TiO₂ nanofibers with respect to airborne pathogen inactivation, efficient VOC oxidation, and the design of photosterilized and photocatalytic materials.

Hereinafter, preferred embodiments are presented to offer aid in understanding the present invention. The following examples are merely illustrative of the present invention, and it is clear to those skilled in the art that various changes and modifications can be made within the scope and spirit of the present invention. Moreover, it is clear that these changes and modifications fall within the scope of the attached claims.

### EXAMPLES

### Example 1 and Comparative Example 1. Preparation of Ag/TiO₂ Nanofibers

First, 1 g of TTIP and 3 mL of acetic acid were dissolved in 6 mL of ethanol. At this time, acetic acid was used to prevent oxidation of the TTIP. Subsequently, 0.45 g of PVP was added to the solution while stirring the solution at 40° C. for 1 hour. Finally, silver nitrate (AgNO₃) was dissolved in the solution. At this time, the amount of silver nitrate was adjusted so that the mole ratios of AgNO₃ to Ti were 0, 0.25, 0.5, 0.75 or 1%. After stirring the solution at room temperature for 1 day, a precursor solution (i.e., electrospinning solution) of a AgNO₃/TTIP/PVP composite was obtained.

Next, the electrospinning solution was injected into a plastic syringe controlled by a syringe pump and electrospun at a flow rate of 5 μL min⁻¹, and electrospinning was performed. At this time, the voltage applied to the metal nozzle (inner diameter=0.67 mm) was +8 kV or −8 kV, and the distance between the tip of the nozzle and the rotating drum collector (200 rpm) was 15 cm.

At this time, the case of using negative voltage pertains to Example 1, and the case of using positive voltage pertains to Comparative Example 1.

Nanofibers (AgNO₃/TTIP/PVP NF) were deposited on top of the drum collector. The spun nanofibers were then placed in a fixed-bed thermal reactor with an inner diameter of 50 mm and a length of 700 mm. The organic components of PVP and TTIP were selectively removed from the nanofibers by performing treatment at 500° C. for 2 hours in the air (flow rate: 2 L/min).

Hereinafter, the heat-treated (pyrolyzed) nanofibers are expressed as Ag/TiO₂ nanofibers (NF). In addition, according to the molar ratio of AgNO₃ to Ti, for example, nanofibers prepared using 0.5% AgNO₃ are expressed as 0.5% Ag/TiO₂ nanofibers (NF).

### Comparative Example 2. Preparation of Ag/TiO₂ Nanoparticles

Ag/TiO₂ nanoparticles were prepared with the same amounts of Ag and TiO₂ as those used in preparing the Ag/TiO₂ nanofibers of Preparation Example 1.

1 g of TTIP was dissolved in 6 mL of ethanol, and silver nitrate was dissolved in the solution so that the molar ratio of AgNO₃ to Ti was 0, 0.25, 0.5, 0.75, or 1%.

Ag/TiO₂ nanoparticles were prepared by electrospraying the solution. Regardless of the type of applied potential, the nanoparticles prepared through electrospraying were dispersed very greatly due to the Columbic repulsion force, and all components of the solution were evenly mixed. Thermal decomposition of the electrosprayed particles was performed as in Example 1, Ag was exposed to the outside by inducing contraction of the nanoparticles, and the TTIP was oxidized to TiO₂.

### Experimental Example 1. Electrohydrodynamic Transport of Silver Ions (Ag⁺) and Nitrate Ions (NO³⁻) while Performing Electrospinning

(1) Method

Utilizing JEOL-7800F (JEOL), images based on field-emission scanning electron microscopy (FESEM) and energy dispersion X-ray spectroscopy (EDS) of Ag/TiO₂ nanofibers (NF) and Ag/TiO₂ nanoparticles (NP) prepared in the Examples were obtained.

In addition, the nanostructure and atomic distribution of NF and NP were investigated using TEM (JEOL JEM-F200).

Moreover, XRD patterns were obtained using a Cu K Al radiation source (45 kV and 200 mA, SmartLab, Rigaku). Narrow and broad scan spectra of XPS were acquired using monochromatic Al K (1486.6 eV) X-ray radiation (K-Alpha, Thermo Scientific). Chemical composition was quantified using XPS Ar⁺ depth profiling with a monochromatic aluminum X-ray source (Al Ka line: 1486.6 eV). The etching duration was 4,200 seconds, and the etching rate for SiO₂ was 0.1 nm/s.

(2) Results

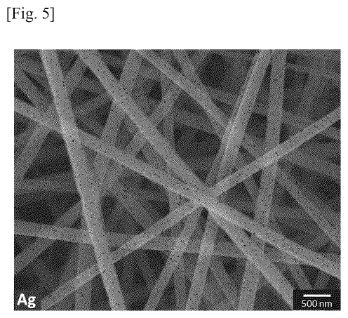

FIG. 5 shows field mapping images of AgNO₃/TTIP/PVP nanofibers electrospun with a negative voltage based on emission scanning electron microscopy SEM-EDS.

As shown in FIG. 5, it can be seen that the AgNO₃/TTIP/PVP nanofibers prepared by applying a negative potential have a continuous and linear structure with a diameter of 200-300 nm. It can be seen that the AgNO₃/TTIP/PVP fibers have a very uniform distribution of Ag on the surface of the fibers.

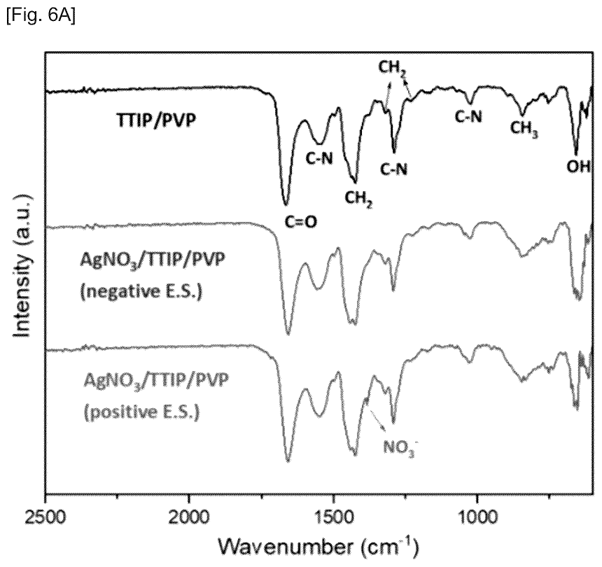

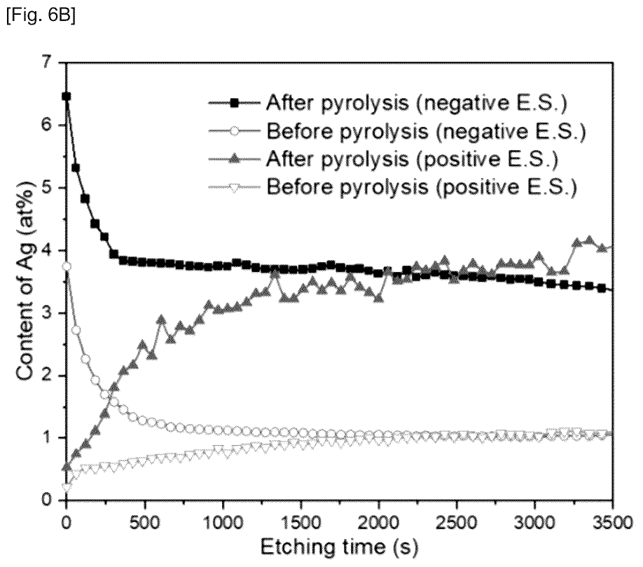

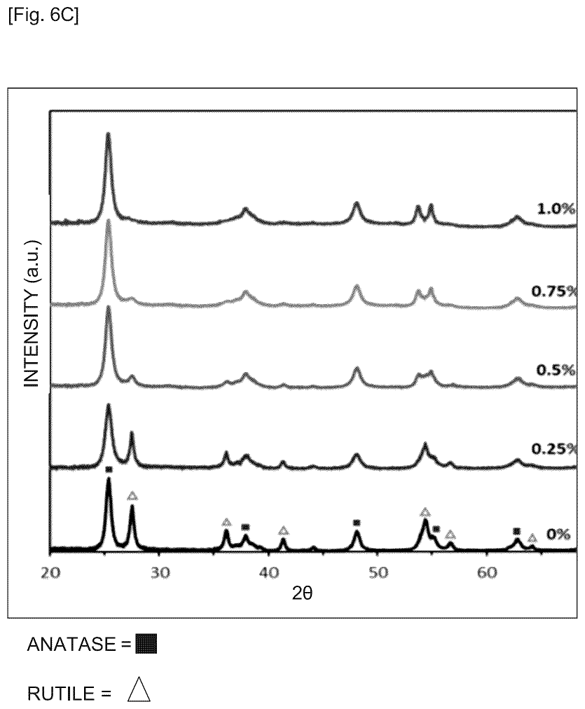

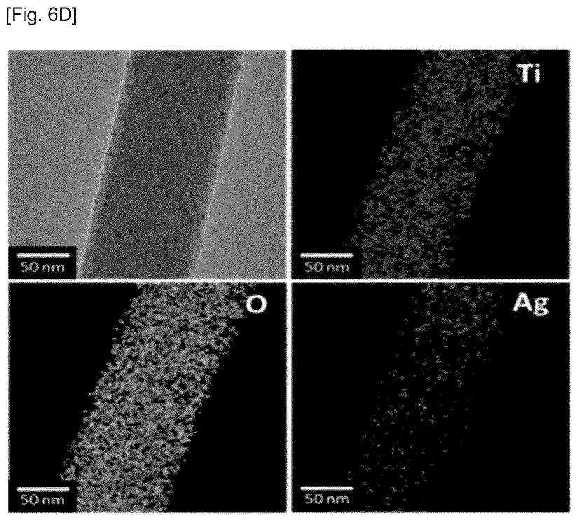

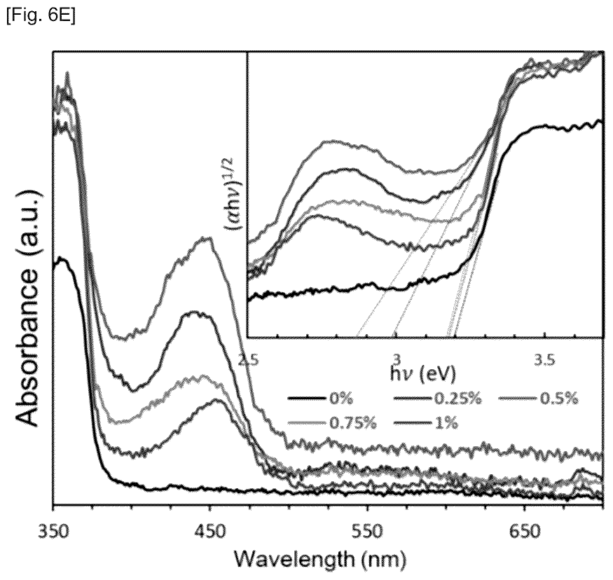

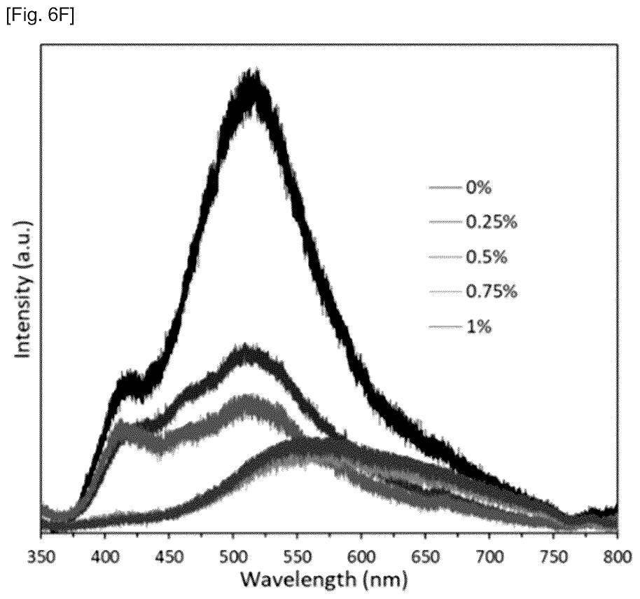

FIG. 6A shows IR spectra of TTIP/PVP electrospun with positive voltage, AgNO₃/TTIP/PVP electrospun with positive voltage, and AgNOs/TTIP/PVP electrospun with negative voltage.

In comparison to TTIP/PVP, AgNO₃/TTIP/PVP fibers electrospun with negative voltage (corresponding to Example 1) have no change in spectral properties, which means there are no silver oxide or other silver-based chemical bonds on the surface of the fibers.

In regards to AgNO₃/TTIP/PVP nanofibers electrospun with positive voltage (corresponding to Comparative Example 1), surface adsorption of the NO₃⁻ band was observed at 1380-1350 cm⁻¹, which is caused by negative ions migrating to the positively charged surfaces of the fibers. This means that there are NO₃⁻ ions on the surfaces.

The concentration of silver ions decreases exponentially as the distance from the nozzle surface increases due to the electrohydrodynamic transport of ions, and the overall shape of the spectrum may change depending on the polarity and magnitude of the applied potential. In addition, as the strength of the applied potential increases, the thickness of the silver ion layer may also increase.

Electrospun fibers were subjected to X-ray photoelectron spectroscopy (XPS) atomic vertical distribution profiling utilizing ion etching.

FIG. 6B shows the atomic content of AgNO₃/TTIP/PVP nanofibers (before pyrolysis) and AgfTiO₂ nanofibers (after pyrolysis) that were electrospun with positive or negative voltage with respect to etching depth.

The silver content of the nanofibers electrospun with a negative voltage prior to thermal decomposition decreased exponentially up to 300 seconds. On the other hand, nanofibers electrospun with positive voltage (0.24%) had a lower initial surface silver concentration than nanofibers electrospun with negative voltage (3.81%). The silver concentration gradually increased until 1500 seconds and remained constant thereafter.

After performing pyrolysis, the total silver content of both fibers increased due to the degradation of PVP. However, the distribution of silver showed a clear difference depending on the polarity of the applied voltage while performing electrospinning. It can be seen that the nanofibers electrospun with a positive voltage and pyrolyzed showed a low silver concentration (0.54%) compared to the initial etching step, whereas the nanofibers electrospun with a negative voltage and pyrolyzed showed a high surface silver concentration (6.42%) compared to the initial etching step.

### Experimental Example 2. Crystallinity and Morphology of Ag/TiO₂

(1) Method

In order to investigate the crystal structure of Ag/TiO₂ (1.0%) nanofibers, X-ray diffraction (XRD) analysis was performed.

(2) Results

The results are shown in FIG. 6C.

FIG. 6C shows the XRD pattern results of Ag/TiO₂ nanofibers. As shown in FIG. 6C, it can be confirmed that all diffraction peaks of the Ag/TiO₂ nanoparticles correspond to the anatase phase of TiO₂ (JCPSD card: 00-021-1272).

Since the presence of PVP lowers the onset transformation temperature, the phase transformation from an anatase phase to a rutile phase can be boosted during thermal decomposition of PVP/TTIP nanofibers at 500° C. The XRD spectra of Ag/TiO₂ nanofibers show no rutile peak due to an increase in silver concentration, indicating that the presence of silver inhibits the transition from an anatase phase to a rutile phase and the anatase phase is not hindered by doping.

Furthermore, FIG. 6D shows a TEM-EDS mapping image of Ag/TiO₂ nanofibers (1.0%).

As shown in FIG. 6D, silver can be identified in the TEM-EDS images, but no diffraction peaks associated with impurity phases related to silver or its oxides were found even at the highest silver concentrations.

### Experimental Example 3. The Optical Properties of Ag/TiO₂

(1) Method

In order to confirm the optical properties of Ag/TiO₂ nanofibers and nanoparticles, UV-vis diffuse reflectance spectra (DRS) was utilized.

In addition, to evaluate the recombination of photo-excited electrons and holes in TiO₂, photoluminescence (PL) emission was investigated.

The light harvesting efficacy was investigated using UV-vis DRS, which was obtained using a UV-vis spectrophotometer (V-650, Jasco). PL spectra were acquired using a He—Cd laser and a 325 nm line from a LabRAM HR800 micro-Raman spectrometer (Horiba Jobin-Yvon).

(2) Results

In the present invention, FIG. 6E shows the UV-vis absorption spectra of Ag/TiO₂ nanofibers (0, 0.25, 0.5, 0.75, 1%) and a plot (inset) of (ah)½ versus energy (hu).

As shown in FIG. 6E, all of the nanofibers and nanoparticles absorbed most of the light at wavelengths less than 400 nm (the UV region). In addition, Ag/TiO₂ nanofibers and nanoparticles show a significant degree of absorption at 400 to 500 nm wavelengths, which can be attributed to the electronic LSPR of silver nanoparticles that are spatially confined. The red shift of the LSPR resonance wavelength based on the addition of silver shows a strong correlation with the degree of silver concentration. As the silver concentration increased from 0.25% to 1%, the absorption peak increased from 432 nm to 456 nm. When the silver concentration exceeds 0.5%, crystallite size tends to increase and absorbance tends to decrease, and thus more light can be scattered.

In a way similar to nanoparticles, nanofibers exhibited the highest absorbance when doped with 0.5% silver, and a redshift appeared as the silver concentration increased. However, the nanofibers showed a stronger red shift than the nanoparticles when the silver concentration was 0.5% (440 nm for nanoparticles and 451 nm for nanofibers).

A larger red shift of the absorption curve can enhance photocatalytic activity by lowering band gap energy and recombination rate. It was possible for Ag/TiO₂ nanofibers to have lower bandgap energy than Ag/TiO₂ nanoparticles because silver was concentrated on the surface of the fibers. For example, the band gap energies of Ag/TiO₂ (0.5%) nanoparticles and nanofibers are approximately 3.14 eV and 2.84 eV, respectively.

Moreover, FIG. 6F shows the PL spectrum of Ag/TiO₂ nanofibers in the range of 350 to 800 nm.

As shown in FIG. 6F, it can be seen that two main emission peaks occur at wavelengths of approximately 420 and 510 nm. The former is produced by band gap transition emission, and the latter is an emission signal induced by charge-transfer transition from Ti³⁺ to oxygen anion in the TiO₆⁸⁻ complex.

As silver concentration increased from 0% to 1%, the PL intensity of nanoparticles and nanofibers gradually decreased under UV light irradiation. As the silver concentration increases, the recombination rate of photoelectron carriers decreases. At a silver concentration of 0.75% or more, it can be seen that the emission peak at 420 nm has almost disappeared. An excessive amount of silver covers the surface of TiO₂, and when light is received, excited electrons move to the silver cluster, preventing the band gap transition in TiO₂. The decrease in PL intensity due to silver doping occurred more dramatically in nanofibers than in nanoparticles. A small amount of silver can be evenly dispersed on the surface of the nanofibers to delay recombination more efficiently than nanoparticles.

### Experimental Example 4. Photocatalytic Methylene Blue (MB) Decomposition

(1) Method

MB is a common colorant used in the textile industry. Because MB possesses a high degree of stability, it has been used as a model compound to investigate the photocatalytic activity of TiO₂ and Ag/TiO₂ nanomaterials.

To evaluate the photocatalytic activity of the nanoparticles and nanofibers, an MB aqueous solution was decomposed at room temperature. A UV-A LED (wavelength: 385 nm, PRIME-100™ Series, Skycares) was used as a UV irradiation source. For visible light irradiation, a 500 W Xe lamp (wavelength: 185-2000 nm, DY. Tech.) with a 400 nm long-pass filter was used as an irradiation source. The light intensity under UV and visible light irradiation conditions was 0.9 mW-cm⁻².

First, 4 mg of Ag/TiO₂ (nanoparticles or nanofibers) was dissolved in 10 ml of deionized water by sonication, and then 0.2 mg of MB was added. The mixture of MB and Ag/TiO₂ was stirred until adsorption-desorption equilibrium was reached. MB degradation was measured at 663 nm (the highest absorption peak) for 180 minutes using a UV-vis spectrophotometer (Libra S12, Biochrom). Decomposition efficiency (r) was determined according to the following formula.

η=1−(A₁₈₀)/(A₀) <Equation 2>

Here, A0 and A180 are absorbances at 0 and 180 minutes, respectively. All MB degradation tests were repeated three times.

(2) Results

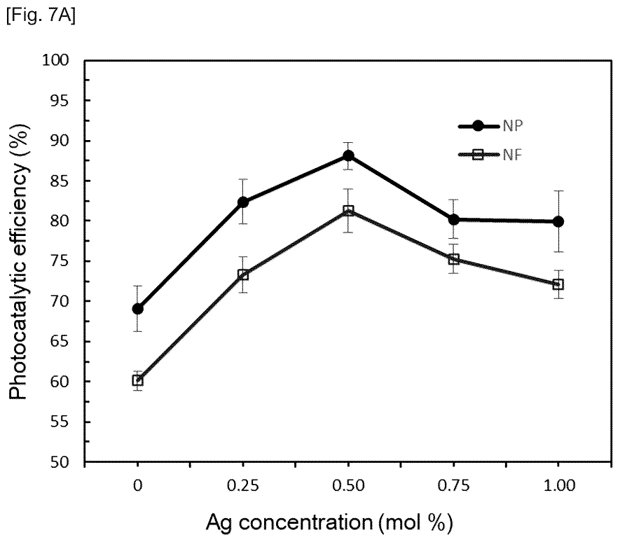

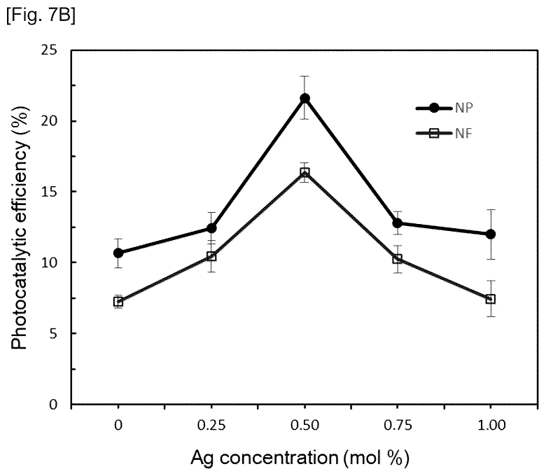

FIG. 7 shows the photocatalytic decomposition of MB caused by the Ag/TiO₂ photocatalyst under UV irradiation (FIG. 7A) and visible light irradiation (FIG. 7B). FIG. 7 confirms the effect of silver doping on the efficiency of photocatalytic decomposition of MB.

When the silver concentration is less than 0.5 mol %, it can be seen that the photocatalytic ability of Ag/TiO₂ steadily increases as the silver concentration increases.

This is due to the following factors.
1) Photoinduced electrons are easily captured by silver in TiO₂ and transported rapidly to oxygen adsorbed on the surface of TiO₂.
2) Silver can generate separated electrons and holes by injecting photoexcited electrons into the conduction band of TiO₂ and react with adsorbates.

However, when the silver concentration increases above 0.5 mol %, the number of active sites that capture photo-generated electrons decreases as the particle size of TiO₂ increases, and the excess silver coats the surface of TiO₂ and reduces the concentration of the photo-generated charge carriers, which can decrease photocatalytic activity.

It can be seen that the overall photocatalytic performance of the nanoparticles is higher than that of the nanofibers, because the nanoparticles that are in the anatase phase and better dispersed in the liquid medium utilize UV light more efficiently than the nanofibers (anatase-rutile mixed phase).

A trend similar to that related to UV irradiation was also observed in visible light irradiation. Both nanoparticles and nanofibers showed the best photocatalytic performance when doped with 0.5% Ag, indicating that silver concentration is important for photocatalytic utilization in visible light.

### Experimental Example 5. Antibacterial Activity of Ag/TiO₂ in a Liquid Medium

(1) Method

E. coli (ATCC-11775) and S. epidermidis (ATCC-14990) were used as test bacteria. Bacteria were cultured in tryptic soy broth (TSB) for 12 hours at 37° C. to yield a cell number of approximately 10⁷ CFU mL⁻¹. Subsequently, the bacterial cells were centrifuged at 6000 rpm for 15 minutes and mixed with 1× phosphate-buffered saline (PBS) solution to prepare a bacterial solution.

First, 5 mg of nanoparticles or nanofibers were mixed with 49.5 mL of PBS and 0.5 mL of bacterial solution. Bacteria and Ag/TiO₂ were mixed at room temperature (300 rpm) using a magnetic stirrer. The mixed solution was left for 15 minutes without receiving UV irradiation, visible light irradiation, or light. A light irradiation condition of 0.25 mW·cm⁻² was selected according to the JIS R 1702 standard method. As the reaction continued, the solution mixture was removed with a pipette at 5 minute intervals. Subsequently, each solution was diluted with PBS to obtain the concentration required for colony enumeration (<500 CFU; colony-forming units). Finally, the solution was placed on an agar plate and incubated at 37° C. for 24 hours.

The number of CFUs was calculated based on visual observation (CCM; colony counting method). The antibacterial efficiency of all of the Ag/TiO₂ samples was determined using the following equation

$${η}_{antibacterial} = 1 - \frac{{CFU}_{sample}}{{CFU}_{control}} \qquad < Equation 3 >$$

In control experiments, grown bacteria (cell count: about 10⁷ CFU mL⁻¹) were left without Ag/TiO₂ under various light irradiation conditions (UV or visible light or no light) for 15 minutes.

(2) Results

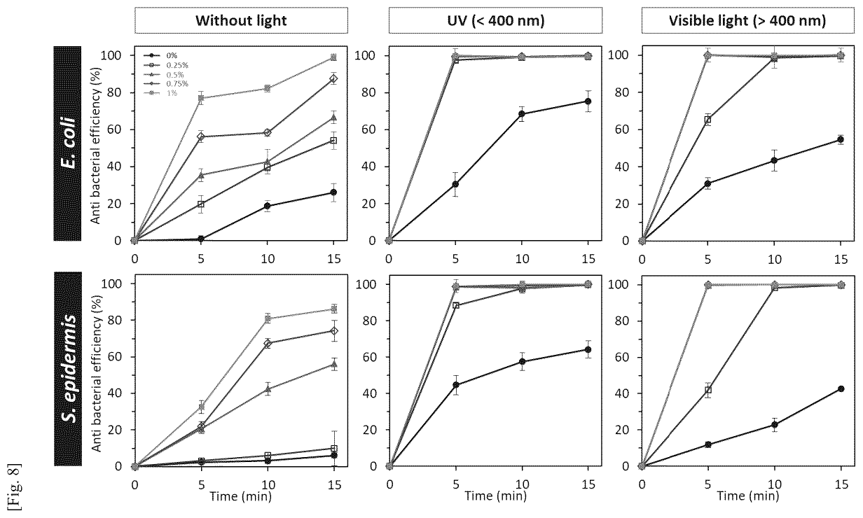

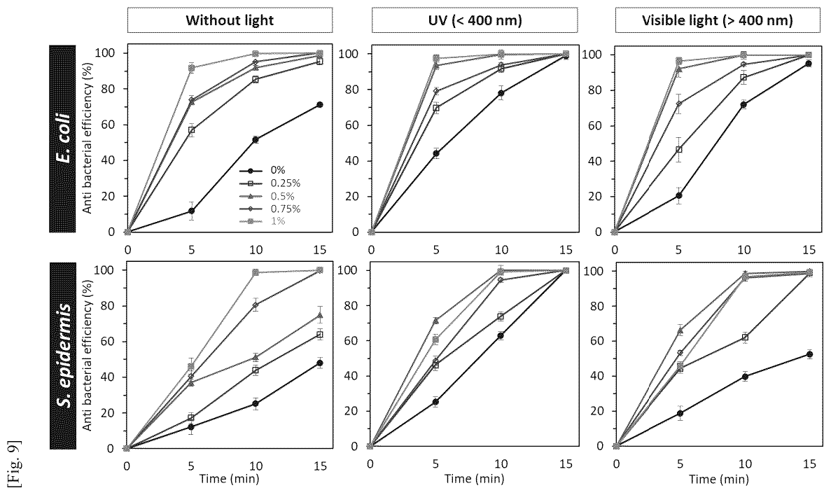

FIG. 8 shows the results of antibacterial analysis of Ag/TiO₂ nanoparticles towards E. coli and S. epidermidis. In addition, FIG. 9 shows the results of antibacterial analysis of TiO₂ nanofibers towards E. coli and S. epidermidis.

As shown in FIG. 8, pure TiO₂ nanoparticles showed a weak antibacterial effect (26.0%) after 15 minutes in the absence of light. Even at very low concentrations, the presence of silver significantly inhibited the growth of E. coli. Approximately 54.2% of the cells were inactivated after 15 minutes.

Higher silver concentrations promoted the inhibition of E. coli growth. This result indicates that 1% Ag/TiO₂ nanoparticles have very high antibacterial efficiency (99.0%) towards E. coli after 15 minutes.

In the case of S. epidermidis, pure TiO₂ nanoparticles inactivated only 6.1% of bacteria at 15 minutes. Ag/TiO₂ nanoparticles with the highest silver doping concentration also showed lower antibacterial activity than E. coli (86.4% after 15 minutes). S. epidermidis is highly resistant towards TiO₂ and Ag/TiO₂ nanoparticles, and the fairly thick cell wall of this gram-positive bacteria is strong enough to inhibit the effects of silver nanoparticles and photogenic ROS. In fact, it can be seen that the antibacterial performance is not greatly improved even when TiO₂ is doped with a very small amount of silver (0.25%) (9.8% after 15 minutes).

Under UV light irradiation, all samples showed improved antibacterial ability towards both E. coli and S. epidermidis. In particular, all of the Ag/TiO₂ nanoparticles exhibited rapid bacterial inactivation of more than 88.0% for a short amount of time (5 minutes). The synergistic effect of the antibacterial ability of silver itself and the photocatalytic reaction of TiO₂ enables rapid inactivation of bacteria.

In addition, complete inactivation of the bacteria was achieved for 5 minutes when the silver concentration was above 0.25% under visible light irradiation. In terms of the photocatalytic decomposition and optical analysis of MB, it was confirmed that the photocatalytic reaction of TiO₂ was limited in visible light and the antibacterial activity was insufficient at low concentrations of silver.

Furthermore, as shown in FIG. 9, in the absence of light, pure TiO₂ nanofibers showed better antimicrobial performance (71.1% and 48.1% (15 minutes) for E. coli and S. epidermidis, respectively) than pure TiO₂ nanoparticles. These results suggest that the nanofibrous form of TiO₂ effectively captures and filters bacteria present in the liquid phase. The antibacterial performance of Ag/TiO₂ nanofibers was significantly improved compared to pure TiO₂ nanofibers.

All of the Ag/TiO₂ nanofibers killed more than 90% of E. coli after 15 minutes and showed quite effective antibacterial activity against S. epidermidis even when the silver doping concentration was low (0.25%). High silver concentrations (0.75% and 1.0%) completely inhibited S. epidermidis growth for 15 minutes. Due to the active interaction between Ag⁺ ions of silver atoms and the bacterial membrane at low coordination and high energy sites (corners, edges, kinks, etc.) related to silver particles exposed on the surface of TiO₂ nanofibers, it is predicted that the antibacterial activity of Ag/TiO₂ nanofibers will be greater than that of Ag/TiO₂ nanoparticles.

Under UV irradiation, 0.5% Ag/TiO₂ nanofibers exhibited high E. coli inactivation efficiency for 15 minutes. In addition, 0.5% Ag/TiO₂ nanofibers inactivated S. epidermidis by 71.6% within 5 minutes, which is superior to nanofibers with higher silver content (0.75, 1.0%). These results suggest that the antibacterial effect of photogenerated ROS based on the optimized concentration of 0.5% Ag/TiO₂ is greater than that of Ag⁺.

When irradiated with visible light, TiO₂ nanofibers showed antibacterial performance similar to antibacterial performance in the absence of light, but Ag/TiO₂ nanofibers showed improved antibacterial performance. After 15 minutes, all of the Ag/TiO₂ nanofibers exhibited 100% antibacterial performance against both types of bacteria. In particular, the 0.5% Ag/TiO₂ nanofibers showed better gram-positive bacteria removal performance than other fibers within 5 minutes (66.4%).

The highest degree of photo-disinfection of S. epidermidis by AgfTiO₂ (0.5%) can be attributed to hot electrons generated from silver, suggesting that photoinduced active species are key to bacterial inactivation under visible light. The photoexcited electrons can move to the conduction band of adjacent TiO₂ and spread to the surface, where ROS can be generated through a redox process.

In the case of Gram-negative bacteria, the antibacterial power of silver itself can easily kill the bacteria, and nanofibers with the highest silver concentration (1.0%) showed the best antibacterial performance (96.6% for 5 minutes). However, Gram-positive bacteria with thick cell walls can be destroyed by radicals generated from photocatalytic reactions rather than by the antimicrobial activity of silver itself. These results indicate that the optimal Ag doping concentration for TiO₂ nanofibers to obtain the highest antibacterial efficiency in visible light is 0.5%.

### Experimental Example 6. Antibacterial Activity of Ag/TiO₂ in an Air Medium

(1) Method

A porous ceramic foam (50×50×9 mm) was placed on a metal drum to collect electrospun nanofiber samples during the electrospinning process. After transferring the ceramic foam coated with the electrospun nanofibers to a heating reactor, the nanofibers were pyrolyzed in order to synthesize Ag/TiO₂ nanofibers.

The antibacterial activity of Ag/TiO₂ nanofibers towards airborne bacteria was tested in a chamber (220 mm×220 mm×220 mm). Centrifuged bacteria were resuspended in 50 mL of DI water before aerosolization with a commercial aerosol generator (3076, TSI) at 2 L·min⁻¹. The bacteria-filled airflow was passed through a diffusion dryer filled with silica gel to remove moisture. Subsequently, a stream of bacteria-filled air was blown into the chamber until the number concentration of the bacterial aerosol reached 3×10⁵ particles per cm³ of air. The water concentration was measured with an aerodynamic particle sizer (APS, 3321, TSI). APS analyzed the concentration of particles with aerodynamic sizes ranging from 0.5 to 20 μm using an optical sensor. Bacteria-filled air was circulated inside the chamber by placing a small fan under the Ag/TiO₂-deposited (area density=0.8 mg/cm²) ceramic foam. Subsequently, the inactivation procedure was performed by i) UV irradiation, ii) visible light irradiation or iii) not providing light for 1 min. Bacteria-filled air was withdrawn from the chamber at a rate of 12.5 L/min for 5 minutes and then placed in buffered saline in an SKC bioSampler (BioSampler, SKC Ltd.). After dilution, the bacterial solution was spread on agar plates and incubated at 37° C. for 24 hours. A control experiment was performed without an inactivation procedure. The overall antibacterial efficiency of all of the Ag/TiO₂ samples was calculated by CCM (see Equation 3).

(2) Results

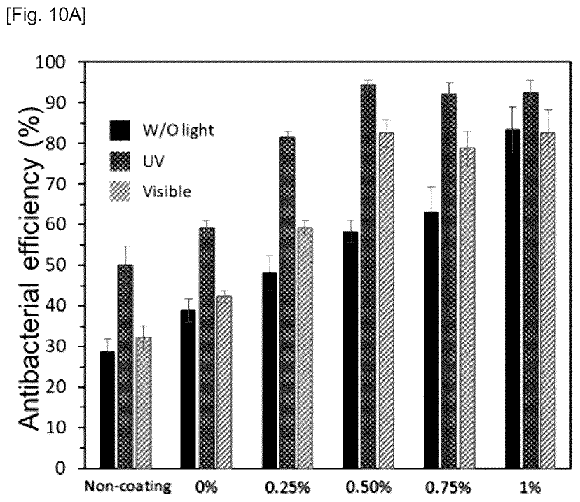

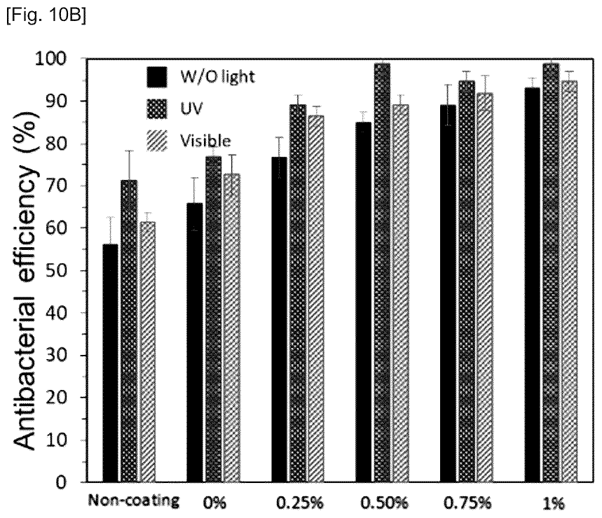

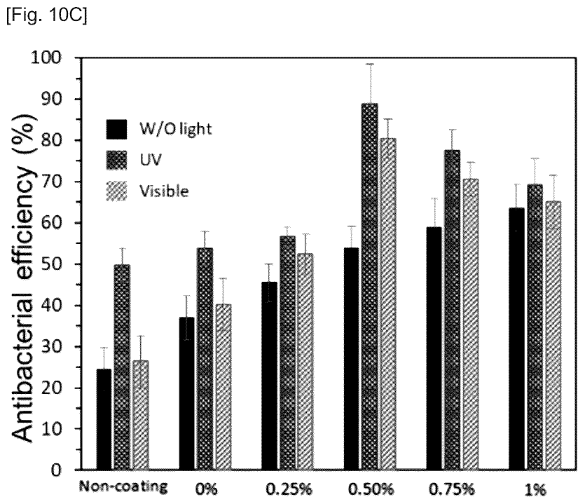

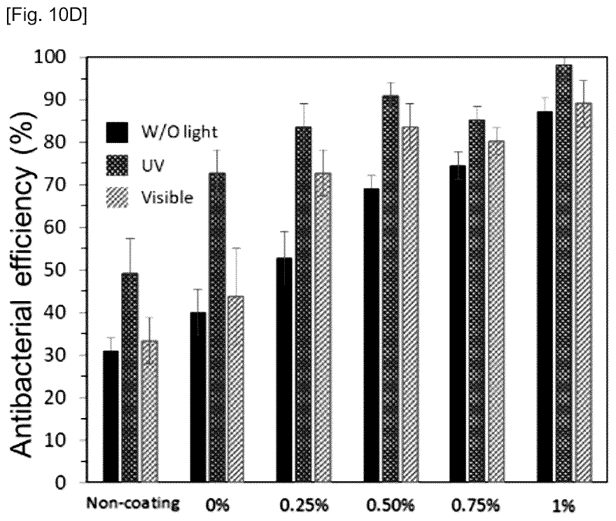

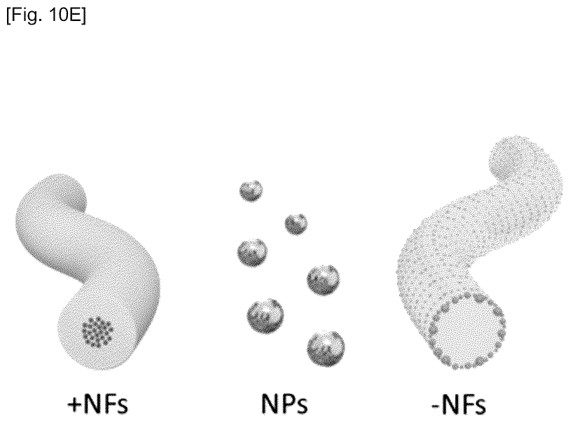

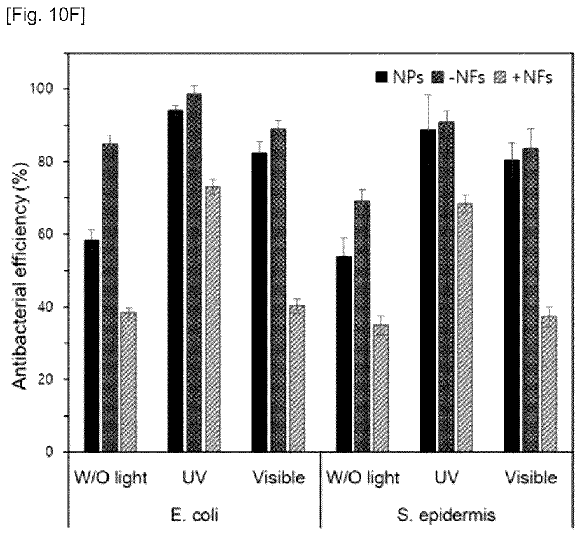

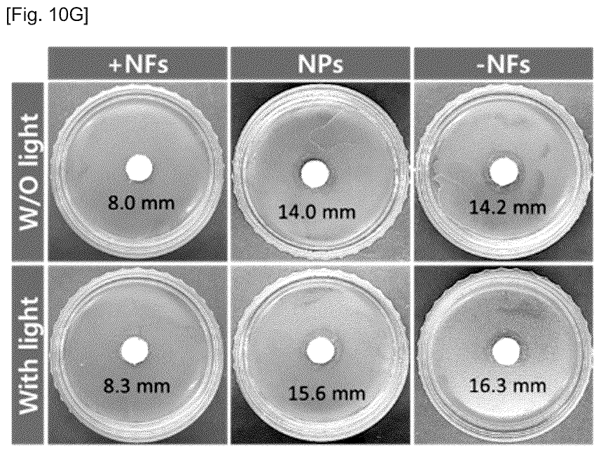

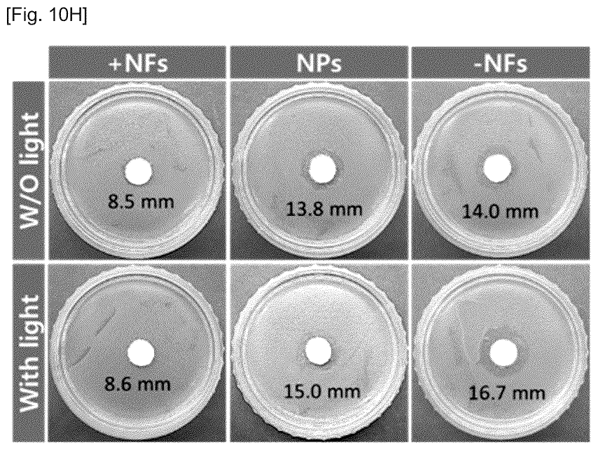

FIG. 10 shows the air medium test results for evaluating the antibacterial activity of Ag/TiO₂ using Gram-negative bacteria (E. coli) and Gram-positive bacteria (S. epidermidis). In FIGS. 10, A and C show the results of the antibacterial activity of nanoparticles, and B and D show the results of the antibacterial activity of nanofibers. In addition, A and B show the results of antibacterial activity towards gram-negative bacteria (E. coli), and C and D show the results of antibacterial activity towards gram-positive bacteria (S. epidermidis).

In the absence of light, Ag/TiO₂ nanoparticles with the highest Ag concentration (1.0%) showed the best antibacterial performance (83.3%) towards E. coli (black bars in FIG. 10A). Under UV and visible light irradiation (red and blue bars in FIG. 10A), 0.5% Ag/TiO₂ nanoparticles showed high antibacterial efficiencies of 94.2% and 82.4%, respectively, and the greater the silver concentration was above 0.5%, the greater the photocatalytic ability of Ag/TiO₂ nanoparticles was reduced under a light irradiation condition.

Due to the physical filtration effect of the fiber membrane, TiO₂ nanofibers (black bars in FIG. 10B) showed better inactivation efficiency than TiO₂ nanoparticles towards E. coli in the absence of light. Under UV irradiation, 0.5% Ag/TiO₂ nanofibers showed the highest antibacterial efficiency towards E. coli (98.6%). As the silver content increased, the antibacterial efficiency of the Ag/TiO₂ nanofibers under visible light increased. However, the antibacterial performance of the 0.75% or 1% Ag/TiO₂ nanofibers did not significantly increase compared to that of Ag/TiO₂ nanofibers in the absence of light. This indicates that when the silver concentration is higher, the overall photocatalytic activity is lower.

In addition, as shown in FIG. 10C, the antibacterial efficiency of Ag/TiO₂ nanoparticles towards Gram-positive bacteria was reduced compared to Gram-negative bacteria. Pure TiO₂ and 0.25% Ag/TiO₂ nanoparticles showed similar antibacterial efficiencies (53.8% and 56.6%, respectively) under UV irradiation in a condition in which there was only ceramic foam without a sample (uncoated, 49.7%), and exhibited inferior photocatalytic activity in an air medium (red bars in FIG. 10C). 0.5% Ag/TiO₂ nanoparticles showed the best antibacterial performance of 88.8% and 80.4% under UV and visible light irradiation, respectively. However, the performance deteriorated as the silver concentration increased.

In the case of Ag/TiO₂ nanofibers, an increase in silver content led to an improvement in antibacterial activity in the absence of light (black bars in FIG. 10D). Throughout the nanofibers, the silver clusters are substantially immobilized and uniformly distributed on the surface TiO₂ fibers and have a large effective surface area. Therefore, it may be the result of increased contact between bacteria and silver particles in the fibrous membrane of Ag/TiO₂ nanofibers during filtration. Under UV radiation (red bars in FIG. 10D), the TiO₂ nanofibers exhibited improved antibacterial efficiency (72.7%) compared to the condition in which there was only ceramic foam (uncoated, 49.7%) and showed the generation of photoinduced ROS. When silver was doped with 0.25% and 0.5%, the antibacterial performance of Ag/TiO₂ nanofibers under visible light increased dramatically compared to the antibacterial performance of Ag/TiO₂ nanofibers in the absence of light. However, the improvement in antibacterial efficiency of silver-doped 0.75% and 1% Ag/TiO₂ nanofibers (80.2% and 89.1%, respectively) under visible light irradiation was not significant compared to the antibacterial efficiency of silver-doped 0.75% and 1% Ag/TiO₂ nanofibers in the absence of light (74.5% and 87.3%, respectively).

Through these results, it can be confirmed that the LSPR effect decreases when the silver concentration in Ag/TiO₂ nanofibers exceeds 0.5%.

### Experimental Example 7. Effect of the Distribution and Morphology of Ag on the Antibacterial Activity of Ag/TiO₂

(1) Method

Experimental Examples 5 and 6 present the antibacterial performance of Ag/TiO₂ nanofibers fabricated by electrospinning in a negative electric field. For the sake of comparison, Ag/TiO₂ nanofibers were fabricated with a positive electric field of the same strength.

The polarity of the electric field that is applied affects the distribution of silver of the nanofibers. As shown in FIG. 10E, the Ag/TiO₂ nanofibers prepared with positive and negative potentials during the electrospinning process are marked with +NF and −NF, respectively. Due to the electrohydrodynamic transport of Ag+ while conducting electrospinning, +NF has the distribution of Ag concentrated inside the nanofibers, while −NF has the distribution of Ag concentrated on the surface thereof. In addition, Ag/TiO₂ nanoparticles marked as nanoparticles were also prepared through electrospray and heat treatment.

Antibacterial tests towards E. coli and S. epidermidis were performed in an air medium using three different types of Ag/TiO₂. The experiment was performed in the same manner as that of Experimental Example 6.

(2) Results

The results are shown in FIG. 10F.

In the absence of light, the release of silver ions from Ag/TiO₂ surfaces is the main mechanism for inactivating bacterial cells. The unique structure of −NF, in which silver clusters were widely distributed on the surface, showed excellent bactericidal properties (84.9 and 69.1% for E. coli and S. epidermidis, respectively). On the other hand, +NF containing silver inside the fibers suppressed silver ion exposure to bacteria and showed the lowest antibacterial performance (38.5% and 35.0% for E. coli and S. epidermidis, respectively). In the case of nanoparticles, theoretically all silver atoms should be uniformly distributed in the TiO₂ particles, but external exposure of silver cannot be maximized due to the presence of silver clumps while performing deposition or pyrolysis. Therefore, the nanoparticles showed lower antibacterial performance than −NF, but they showed better antibacterial performance than +NF.

TiO₂ in the form of nanofibers may have a large specific surface area and the ability to trap aerosolized bacteria. Therefore, −NF exhibited better antibacterial efficiency than nanoparticles towards both types of bacteria under UV irradiation. In visible light, both nanoparticles and −NF exhibit improved antibacterial efficiency compared to when there is the absence of light, confirming that both nanoparticles and −NF have an LSPR effect. However, +NF did not induce a photocatalytic reaction when irradiated with visible light due to the embedded Ag and showed limited antibacterial efficiency, which was similar to the antibacterial efficiency shown in the absence of light.

In addition, the antibacterial properties of HEPA filter discs mixed with Ag/TiO₂ towards MDR strains (e.g. extended spectrum β-lactamase-producing E. coli, ESBL-producing E. coli, methicillin-resistant Staphylococcus aureus, and MRSA) were investigated by a disk diffusion method (DDM).

Images and diameters of inhibition zones for ESBL-produced E. coli and MRSA are shown in FIGS. 10G and 10H, respectively.

In the absence of light irradiation, it can be seen that the edges of the +NF disks are almost completely contaminated (diameters of 8 mm and 8.5 mm in the cases of ESBL-produced E. coli and MRSA, respectively). However, the discs mixed with nanoparticles and −NF resisted contamination.

It has been suggested that silver cations interact with bacterial membranes to inactivate enzymes and inhibit bacterial cell growth. In the same context, nanoparticles with high external exposure of silver and −NF have better antibacterial effects than +NF. Under visible light irradiation, the diameter of the inhibition zone for ESBL-producing E. coli was 15.6 mm (11%) for nanoparticles and 16.3 mm (15%) for −NF in comparison to the diameter in the absence of light (in the case of 14.0 mm and 14.2 mm). In the case of MRSA, nanoparticles and −NF increased the inhibition zone by 8% (13.8-15.0 mm) and 19% (14.0-16.7 mm), respectively, in visible light compared to the case in which there was the absence of light. These results demonstrate the sustained generation of ROS due to the LSPR effect on silver on the surface of TiO₂. In +NF, the antibacterial performance was not particularly improved under visible light due to improper distribution of silver in the fibers, whereas in −NF, the antibacterial performance was improved the most under visible light due to the unique distribution of silver on the surface of the fibers.

### Experimental Example 8. Antiviral Activity of Ag/TiO₂ in a Liquid Medium

(1) Method

For the antiviral test, H1N1 (A/California/4/2009) and H3N2 (A/Brisbane/10/2007) viruses obtained from the BioNano Health-Guard Research Center (Daejeon, Korea) were used. To prepare each virus solution, 0.05 mL of thawed virus stock (initial titer 1011 PFU·mL⁻¹) was mixed with 50 mL of DI water. Typically 1 mg of nanoparticles or nanofibers were introduced into a 50 mL open conical tube through which the viral solution was transported. The viruses and Ag/TiO₂ were magnetically stirred (300 rpm) at room temperature and then exposed to UV light, visible light, or not exposed to light for 15 minutes. The illumination intensity was 0.25 mW·cm⁻².

Antiviral performance was confirmed using real-time qRT-PCR (TCR0096, Thermo Scientific). The RNA of the virus samples was extracted with the Power Prep Quick RNA Extraction Kit (E0014, Kogenebiotech) and combined with each extracted RNA sample extracted using the PowerChek Pandemic H1N1/H3N2 Real-time PCR Kit Ver. 1.0 (R3410, Kogenebiotech), which were tested for H1N1 and H3N2. The cycling protocol was as follows: 30 min of Uracil DNA Glycosylase activation at 50° C., 10 minutes of initial denaturation at 95° C., 40 or 45 cycles of denaturation at 95° C. for 15 seconds, and 1 minute of annealing and extension at 60° C. All real-time qRT-PCR tests were performed three times. The overall antiviral efficiency of each Ag/TiO₂ sample was determined using the following formula.

$${η}_{antiviral , PCR} = 1 - \frac{1}{{2}^{{Ct}_{sample} - {Ct}_{control}}} \qquad < Equation 4 >$$

Here, Ct is the cycle threshold number. Experiments were performed with Ag/TiO₂ in the absence of light as a control. All tests were performed under standard atmospheric conditions of 35% relative humidity.

(2) Results

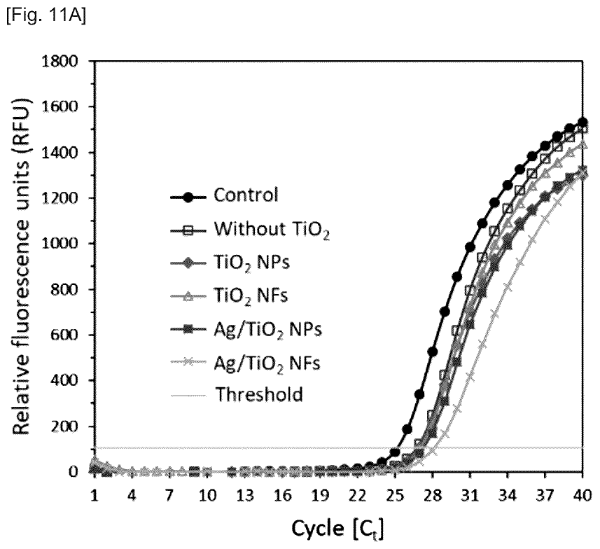

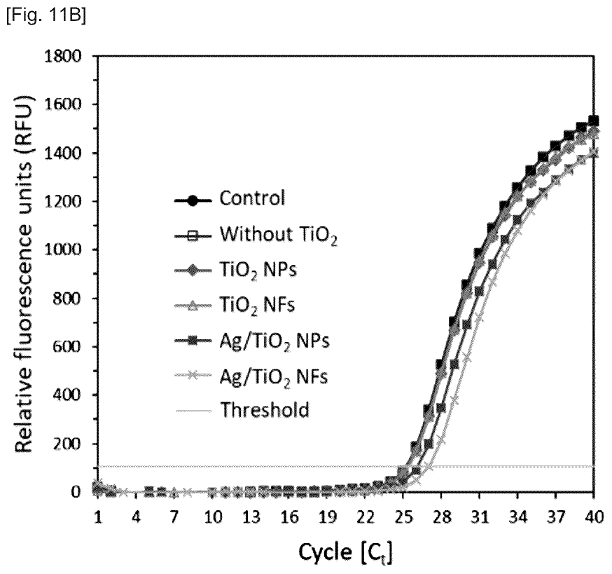

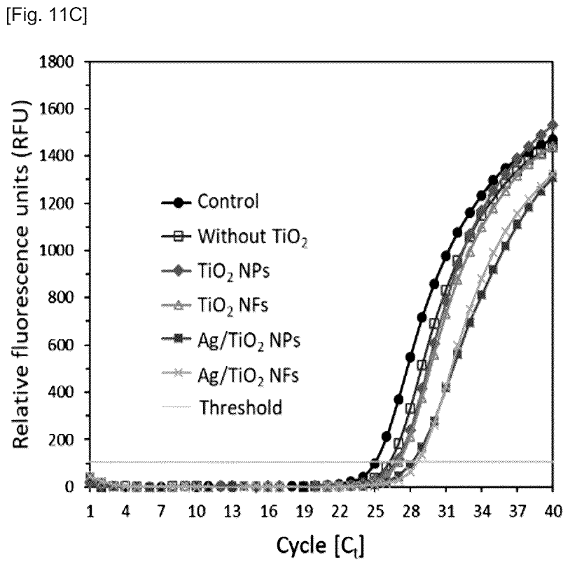

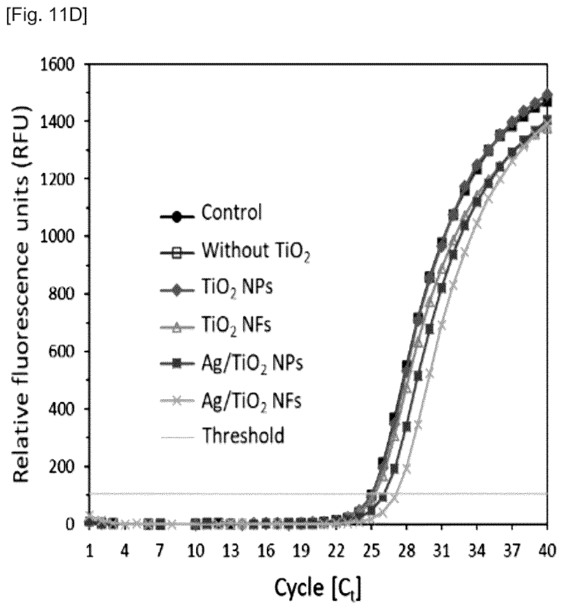

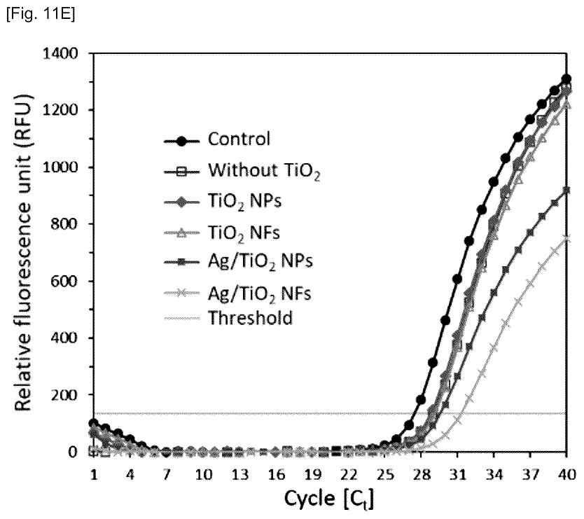

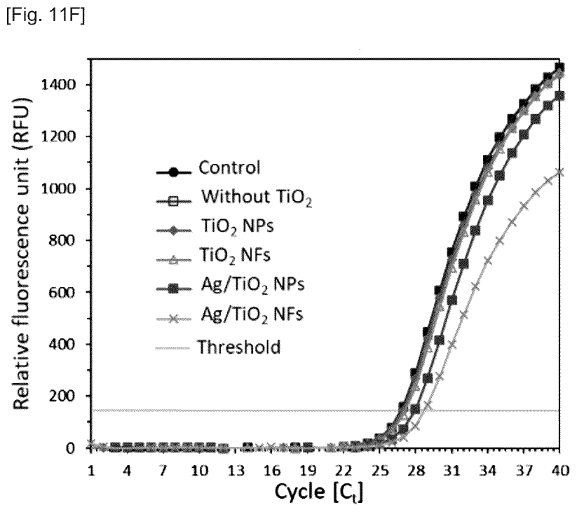

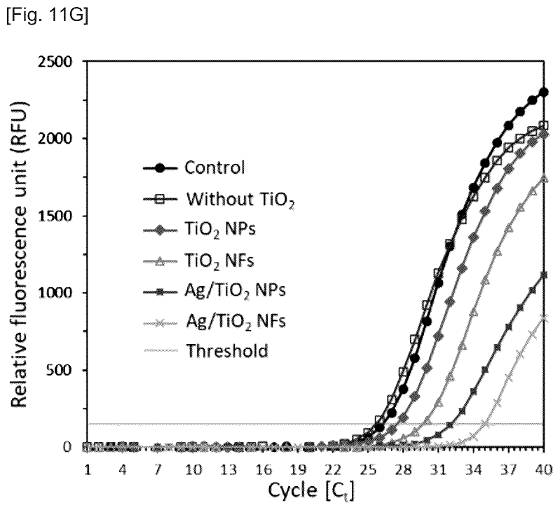

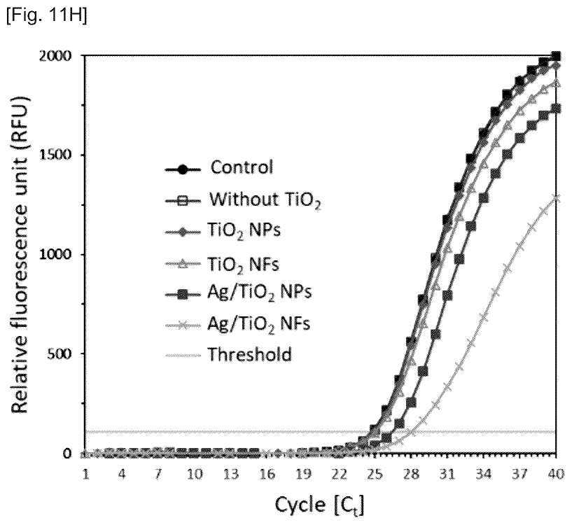

FIG. 11 shows the results of antiviral analysis for H1N1 and H3N2 using Ag/TiO₂, showing qRT-PCR amplification curves obtained for H1N1 and H3N2 influenza viruses in multiplex PCR reactions. Specifically, FIG. 11A and FIG. 11E are UV light irradiation conditions for H1N1, FIG. 11B and FIG. 11F are visible light irradiation conditions for H1N1, FIG. 11C and FIG. 11G are UV light irradiation conditions for H3N2, FIG. 11D and FIG. 11H show the results for H3N2 under a visible light irradiation condition. Further, FIG. 11A to FIG. 11D are results obtained in a liquid medium, and FIG. 11E to FIG. 11H are results obtained in an air medium.

It can be seen that all samples under UV light irradiation achieved improved antiviral ability against H1N1 and H3N2 compared to the cases that were without samples. PCR analysis demonstrated that nanofibers were substantially more effective in terms of achieving inactivation than nanoparticles due to the filtration effect of the fibrous membrane. Ag/TiO₂ nanofibers showed the best inactivation performance with 87.5% and 91.3% for H1N1 and H3N2, respectively.

Under visible light, Ag/TiO₂ showed higher antiviral efficacy than pure TiO₂. In particular, Ag/TiO₂ nanofibers showed the highest inactivation performance towards H1N1 and H3N2 at 71.9% and 76.7%, respectively. The excellent antiviral performance of AgfTiO₂ nanofibers is derived from the intrinsic localized silver on the surfaces of TiO₂, which induces high photocatalytic activity including the LSPR effect and promotes the release of Ag+ or Ag2+.

### Experimental Example 9. Antiviral Activity of Ag/TiO₂ in an Air Medium

(1) Method

For antiviral testing, viruses were aerosolized and blown into the chamber at an airflow rate of 2 L·min⁻¹. A ceramic foam sample deposited with Ag/TiO₂ was placed in the chamber. After 3 minutes, the inactivation procedure was performed by i) UV irradiation, ii) visible light irradiation or iii) no light for 1 minute. Finally, the air containing the viruses was evacuated (12.5 L/min for 5 minutes) and placed in the SKC bioSampler's buffered saline. RNA of each virus sample was extracted and analyzed by the method presented in (the liquid medium test). All tests were performed under standard atmospheric conditions of 35% relative humidity.

(2) Results

Under UV irradiation in the absence of TiO₂, 64.6% of H1N1 was inactivated, but the antiviral effect was not significantly improved when TiO₂ or Ag/TiO₂ nanoparticles were irradiated.

Only Ag/TiO₂ nanofibers were able to inactivate H1N1 by more than 90%. When irradiated with visible light in the absence of TiO₂, there was no antiviral effect, and even when irradiated with visible light with pure Ag/TiO₂, a significant antiviral performance was not shown.

However, due to the LSPR excitation of silver, Ag/TiO₂ can show excellent antiviral performance even in visible light, and Ag/TiO₂ nanofibers, which have relatively greater photocatalytic and filtration effects, showed superior antiviral performance compared to Ag/TiO₂ nanoparticles.

The antiviral test for H3N2 showed a similar trend to that of H1N1, and Ag/TiO₂ nanofibers showed the best antiviral performance under UV light and visible light.

### Experimental Example 10. Photocatalytic Decomposition of Acetaldehyde by Ag/TiO₂

(1) Method

[Continuous Flow Test]

The photocatalytic oxidation efficiency of Ag/TiO₂ compared to acetaldehyde was evaluated.

Clean air (0.1 L·min⁻¹) and standard acetaldehyde gas (100 ppmv, 100 ppmv, 0.02 L·min⁻¹, balanced with N2 gas) were passed through a cuboid metal reactor (160 mm×100 mm×35 mm) at 20° C., and 0.05 g of Ag/TiO₂ was put into the reactor. Before testing, each sample was completely degassed at 200° C. for 1 hour under a nitrogen stream of 2 L·min⁻¹ and then cooled to room temperature. To activate the photocatalyst, a Xe lamp was installed above the reactor at an intensity of 300 Wm⁻² 10 cm. For UV and visible light irradiation, 400 nm short-pass and long-pass filters were used, respectively. Quartz was placed on top of the reactor so that the light from the lamp could pass through to the reactor. The sustained photocatalytic oxidation efficiency of acetaldehyde with Ag/TiO₂ under steady-state conditions was determined by measuring acetaldehyde gas concentrations (ppmv) at the inlet and outlet with a gas chromatograph-flame ionization detector (GC-FID, 7890B, Agilent Technologies) at 12 min intervals. Each test was repeated three times.

[Closed-Cyle Test]

Photocatalytic oxidation of gaseous acetaldehyde was performed in a batch reactor with 0.05 g Ag/TiO₂ placed at the bottom of the reactor using a Xe lamp (300 Wm⁻²) and a cylindrical quartz reactor (internal diameter 70 mm, total volume: 385 mL). After adding 100 L of liquid acetaldehyde, the reactor was sealed. After vaporization of acetaldehyde and equilibration of gas-solid adsorption, the test was continued. The time-dependent photocatalytic oxidation efficiency of Ag/TiO₂ to acetaldehyde was evaluated by measuring the CO₂ concentration at different time intervals using a photoionization detection gas analyzer (Kinsco Inc.). The CO₂ conversion rate was determined by the following formula.

$${CO}_{2} conversion ( \% ) = \frac{\frac{{V}_{r} {C}_{g} δ}{vM}}{\frac{{V}_{l} δ}{M}} \times 100 = \frac{{V}_{r} {C}_{g}}{{vV}_{l}} \times 100 \qquad < Equation 5 >$$

Here, Vr and Vl are the volume of the reactor and injected liquid, respectively; δ, M and v are the density, molecular weight and number of carbon atoms of VOC, respectively. Cg is the concentration of CO₂.

(2) Results

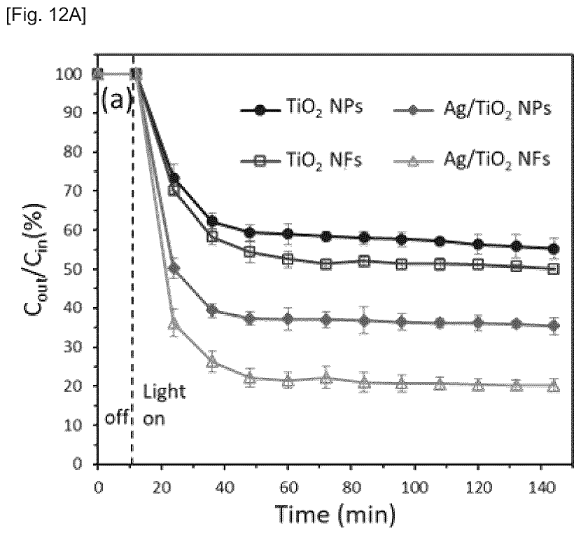

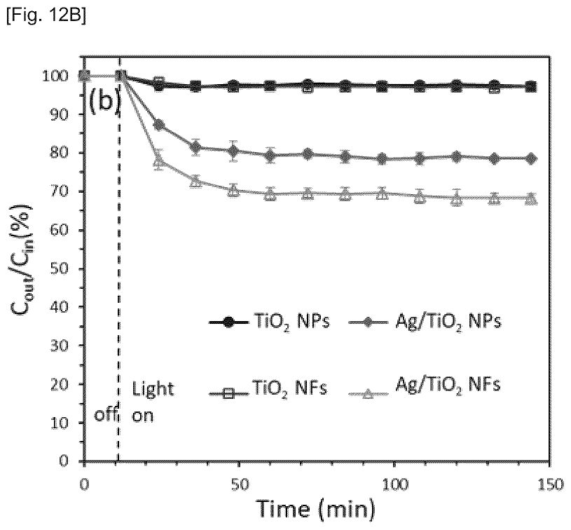

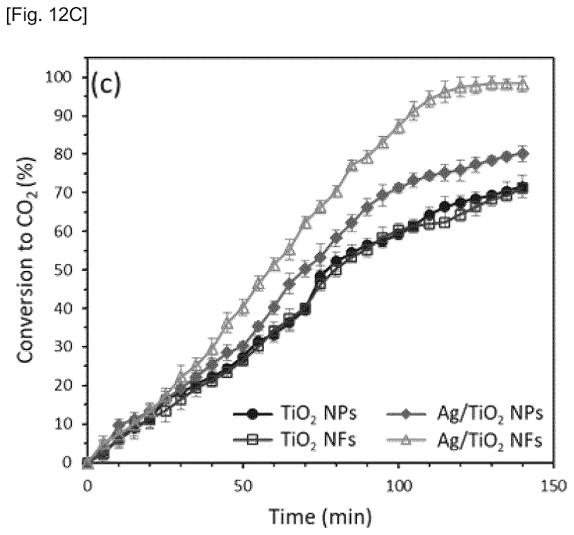

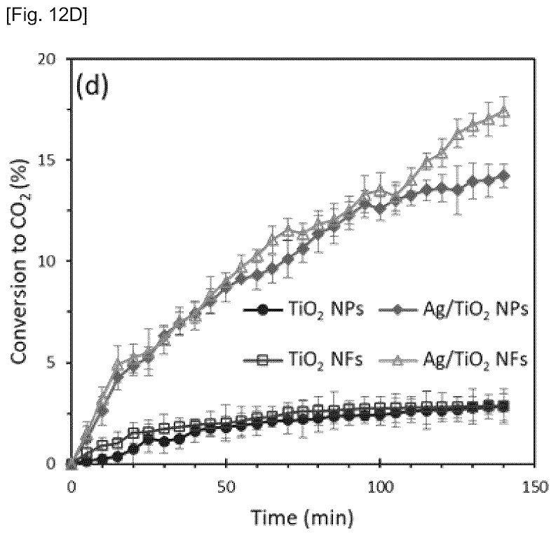

The continuous flow test was measured for 144 minutes, and the results are shown in FIG. 12.

Under UV light irradiation (FIG. 12A), Cout/Cin at 144 minutes decreased in the following order pure TiO₂ nanofibers (55.3%)>pure TiO₂ nanoparticles (50.1%)>Ag/TiO₂ nanoparticles (35.4%)>Ag/TiO₂ nanofibers (20.2%).

The photocatalytic activity of TiO₂ nanofibers was higher than that of nanoparticles because nanofibers having a larger specific surface area than nanoparticles absorbed more UV light. Ag/TiO₂ has improved photocatalytic oxidation performance due to the long-term separation of electrons and holes caused by the presence of silver. In particular, Ag/TiO₂ nanofibers showed the best performance in acetaldehyde photooxidation and exhibited the lowest recombination resistance and the longest electron lifespan due to the concentration of silver on the surface of TiO₂.

Under visible light irradiation, the photocatalytic oxidation ability of TiO₂ nanoparticles and nanofibers was limited to less than 3% for 144 minutes (FIG. 12B). On the other hand, Ag/TiO₂ nanoparticles and Ag/TiO₂ nanofibers showed oxidation efficiency of 20 to 30% for 144 minutes due to the LSPR excitation of silver.

Similar to the results of the antibacterial and antiviral tests, Ag/TiO₂ nanofibers that can exert the greatest LSPR effect showed the highest oxidation efficiency.

Moreover, the photocatalytic oxidation characteristics of gaseous acetaldehyde in a closed circulation system were evaluated based on TiO₂ and Ag/TiO₂ under UV or visible light irradiation.

CO₂ was produced by photolysis of acetaldehyde under UV irradiation within 140 minutes (FIG. 12C). The highest CO₂ conversion at all intervals was achieved by Ag/TiO₂ nanofibers; the CO₂ conversion for Ag/TiO₂ nanofibers (98.4%) within 140 minutes was higher than Ag/TiO₂ nanoparticles (80.1%), TiO₂ nanoparticles (71.6%) and TiO₂ nanofibers (71.2%).

In the presence of TiO₂ and Ag/TiO₂, acetaldehyde was steadily mineralized to CO₂ under UV light. Under visible light irradiation, the low CO₂ conversion rate in relation to a UV irradiation condition can confirm the incompleteness of the decomposition reaction of acetaldehyde (FIG. 12D).

TiO₂ nanoparticles and nanofibers showed little (2.8%) conversion of acetaldehyde to CO₂ at 140 minutes. On the other hand, Ag/TiO₂ nanoparticles showed a CO₂ conversion efficiency of 14.2% for 140 minutes due to LSPR excitation. In particular, Ag/TiO₂ nanofibers showed the highest efficiency (17.4%), showing potential as a sustainable visible photocatalyst that can completely remove VOCs.

1. A method for producing titanium dioxide nanofibers doped with noble metals on the surface comprising:
preparing nanofibers by electrospinning an electrospinning solution containing a noble metal inorganic salt, a titanium precursor, and a polymer while applying a negative voltage; and
heat-treating the electrospun nanofiber to expose noble metals on the surface of the nanofibers and oxidizing the titanium precursor to titanium dioxide.

2. The method for producing titanium dioxide nanofibers doped with noble metals on the surface according to claim 1,
wherein noble metal inorganic salts include at least one selected from the group consisting of silver nitrate (AgNO₃), chloroplatinic acid (H₂PtCl₆), palladium chloride (PdCl₂), ruthenium chloride (RuCl₃), chloroauric acid (HAuCl₄), nickel chloride (Nickel chloride, NiCl₂), copper chloride (CuCl₂), gold chloride (AuCl, AuCl₃), palladium nitrate (Pd(NO₃)₂·2H₂O), silver chloride (AgCl), chloroauric acid (HAuCl₄), sodium palladium chloride (Na₂PdCl₄) platinum chloride (PtCl₄) tetraaminepalladium dinitrate (Pd(NH₃)₄(NO₃)₂) and palladium chloride (Cl₂Pd).

3. The method for producing titanium dioxide nanofibers doped with noble metals on the surface according to claim 1,
wherein the content of the noble metal inorganic salt is 0.1 to 5% by weight based on the total weight of the electrospinning solution.

4. The method for producing titanium dioxide nanofibers doped with noble metals on the surface according to claim 1,
wherein the titanium precursor is at least one selected from the group consisting of titanium isopropoxide (TTIP), titanium butoxide (C₁₆H₃₆O₄Ti) and titanium (IV) acetylacetonate (Ti(C₅H₇O₂)₄).

5. The method for producing titanium dioxide nanofibers doped with noble metals on the surface according to claim 1,
wherein the molar ratio of noble metal inorganic salt to titanium (Ti) is 0.1 to 2%.

6. The method for producing titanium dioxide nanofibers doped with noble metals on the surface according to claim 1,
wherein the polymer is at least one selected from the group consisting of polyvinyl pyrrolidone (PVP), polyacrylonitrile (PAN), polyurethane (PU), polybenzimidazole (PBI), polycarbonate (PC), polyvinyl alcohol (PVA), polylactic acid (PLA), polyethylene-co-vinyl acetate (PEVA), polymethacrylate (PMMA), polyethylene oxide (PEO), polyaniline (PANI), polyvinylchloride (PVC), polycaprolactone (PCL), polyether imide (PEI), poly(vinylidene fluoride) (PVDF), polyethylene glycol (PEG), poly(2-hydroxyethyl methacrylate) (HEMA), collagen, poly(ferrocenyldimethylsilane) (PFDMS), and polystyrene (PS)

7. The method for producing titanium dioxide nanofibers doped with noble metals on the surface according to claim 1,
wherein the solvent of the electrospinning solution is at least one selected from the group consisting of dimethylformamide (DMF), dichloromethane, distilled water, chloroform, acetone, ethanol, hydrochloric acid, formic acid, tetrahydrofuran, and isopropanol.

8. The method for producing titanium dioxide nanofibers doped with noble metals on the surface according to claim 1,
wherein in electrospinning, the flow rate of the electrospinning solution is 1 to 15 μL/min, the inner diameter of the nozzle is 0.4 to 2 mm, and the distance between the nozzle and the substrate is 10 to 50 cm.

9. The method for producing titanium dioxide nanofibers doped with noble metals on the surface according to claim 8,
wherein the substrate is a rotating drum.

10. The method for producing titanium dioxide nanofibers doped with noble metals on the surface according to claim 1,
wherein in electrospinning, a negative voltage of −5000 V to −20000 V is applied to the tip of a nozzle.

11. The method for producing titanium dioxide nanofibers doped with noble metals on the surface according to claim 1,
wherein heat treatment is performed at 300 to 600° C. for 30 to 180 minutes.

12. The method for producing titanium dioxide nanofibers doped with noble metals on the surface according to claim 1,
wherein electrospinning and heat treatment are performed in a roll-to-roll device,
wherein the roll-to-roll device includes a first roller (rotating drum) in which a pre-spinning solution is electrospun to produce nanofibers; and a second roller on which the nanofibers manufactured by the first roller are wound; and
a heat treatment device for heat treating the nanofibers located between the first roller and the second roller.

13. Titanium dioxide nanofibers doped with noble metals on the surface produced by the manufacturing method according to claim 1, including
titanium dioxide nanofibers; and
noble metal particles protruding from the surface of the titanium dioxide nanofibers.
